(19) United States
(12) Patent Application Publication
(10) Pub. No.: US 2012/0035975 A1
(43) Pub. Date: Feb. 9, 2012

(54) METHOD AND APPARATUS FOR CREATING WORK PLAN

(75) Inventors: Yohei SUGIMOTO, Hitachi (JP); Kenichiro Yamane, Hitachi (JP); Masatoshi Takada, Mito (JP)

(73) Assignee: HITACHI, LTD.

(21) Appl. No.: 13/196,019

(22) Filed: Aug. 2, 2011

(30) Foreign Application Priority Data
Aug. 4, 2010 (JP) 2010-175566

(51) Int. Cl. G06Q 10/00

(52) U.S. Cl. 705/7.26

(57) ABSTRACT

Creation of detailed work plan related to works of assembling a large scale structure, such as plant construction, is aided by enabling parallel works on plural components in a work area and avoiding spatial interference between works. A method for creating detailed work plans includes step of generating component groups by dividing plural components for large scale structure into work assignment units, step of assigning the respective component groups to one or more work teams assigned in an outline process plan, step of creating each detailed work plan by determining the execution sequences of detailed works on component-by-component basis in a corresponding work team, using work sequence restriction and a work priority rule, and step of avoiding work interference that revises the execution sequence of the detailed works such as to avoid overlapping between work spaces among the determined detailed works if spatial overlapping is present among detailed works.

### CROSS REFERENCE TO RELATED APPLICATIONS

The present application claims benefit of the filing date of Japanese Patent Application No. 2010-175566 filed on Aug. 4, 2010.

### BACKGROUND OF THE INVENTION

1. Field of the Invention

The present invention relates to a work plan creating method and apparatus for creating detailed work plans on component-by-component basis from a given outline process plan in a field related to assembling work of a large scale structure, such as plant building.

2. Description of the Related Art

In constructing a plant, such as a power plant, a chemical plant, and the like, which requires a number of component assembling works on construction site, it is necessary to proceed construction while linking various works in a complex manner. Accordingly, for meeting the due date of completion of construction and further shortening the construction period, it is important to create detailed work plans for a highest possible work efficiency in advance taking into account the work sequence, the contents of works, and the like on the construction site, and proceed the work according to the plan.

In creating such detailed work plans, in general, a site supervisor first creates a rough process plan (outline process plan) for each work area in a plant building, then creates a detailed work plan on work-by-work basis on the site, based on experience and knowhow, while viewing design drawings or a screen of a three dimensional CAD (Computer Aided Design) system. However, the number of components is so large that it takes a huge work and time to manually create a detailed work plan for construction of a large scale plant. In this situation, a site supervisor sometimes instructs the next work, checking the current state of the site each time without creating a detailed work plan.

On the other hand, as the demand for nuclear power generation tends to globally increase, a situation possibly occurs that a plurality of nuclear power plants need to be simultaneously constructed, which may cause a problem of a potential shortfall of site supervisors with rich experience. In this case, a method of plant construction that is dependent only on the experience and knowhow of a site supervisor possibly causes a serious problem in terms of meeting the due date of completion and the like. In this situation, there is an understanding that it is important to develop a technology for automatically generating detailed work plans with high quality that contributes to smooth proceedings of works.

As a conventional technology related to the above, Patent Document 1 (JP H08-63496 A) discloses a technology in which a work space is defined for each individual kind of component (equipment unit, pipe, etc.) and a work procedure is determined on component-by-component basis in each work area such that the occupancy ratio of existing components which are present in the work space in performing works of respective components is minimized. Further, Patent Document (JP 2002-123786 A) discloses a technology for determining a work procedure on component-by-component basis in each work area, based on the installation positions of the components.

### SUMMARY OF THE INVENTION

### Problems to be Solved

In both the conventional technologies described above, it is assumed that works on components, which are present in a work area, are sequentially performed one by one. However, practically, in a case, for example, where construction in a short period is required, or in a case of trying to recover a work delay, it is often forced to proceed a plurality of works in parallel, assigning a plurality of work teams simultaneously in the same work area. In such a case, it is necessary for a site supervisor to manually revise a work plan created by the above-described conventional technologies into a work plan in consideration of parallel works. However, if the number of components is large, it is particularly difficult, to revise a work plan so as to prevent spatial interference which may occur during parallel works. Consequently, interference between works sometimes has caused a work delay.

The present invention has been developed to solve the above-described problem, and an object of the invention is to aid creation of detailed work plans such as to enable parallel works on a plurality of components which are present in the same work area and also to prevent occurrence of spatial interference between works.

### Means for Solving the Problems

In order to attain the above-described object, the present invention provides a work plan creating method for creating detailed work plans, wherein an outline process plan of works of assembling a structure with a plurality of components on site, and attribute information including kinds, three-dimensional shapes, and installation positions of the components, are given, and wherein a detailed work plan is created on component-by-component basis, by using the outline process plan and the attribute information, the method including the steps of: providing a work plan creating apparatus which performs the work plan creating method, a component group generating step of generating component groups by dividing the plurality of components into units of work assignment, corresponding to the respective kinds of the plurality of components; a work team assigning step of assigning, with a predetermined standard, the each generated component group to one or more work teams having been assigned in the outline process plan to an outline process that corresponds to the each generated component group; a detailed work plan creating step of creating each detailed work plan by determining an execution sequence and a work schedule of detailed works on component-by-component basis in a corresponding work team, based on a predetermined work sequence restriction and a predetermined work priority rule; and a work interference avoiding step, wherein, among the individual detailed works that form the created detailed work plan, if a detailed work is present that is executed in parallel with another detailed work and causes work interference due to overlapping between work spaces, the step revises the execution sequence of the detailed works, such as to avoid the work interference.

### BRIEF DESCRIPTION OF THE DRAWINGS

FIG. 1 is a function block diagram showing an example of the entire configuration of a work plan creating system;

FIG. 2 shows an example of a data structure and data of a CAD component DB;

FIG. 3 shows an example of a data structure and data of an outline process planning DB;

FIG. 4 shows an example of a data structure and data of a component—outline process association DB;

FIG. 5 shows an example of a data structure and data of a work team DB;

FIG. 6 shows an example of a data structure and data of a detailed work plan DB;

FIG. 7 is a flowchart of the overall process of a work plan creating apparatus;

FIG. 8 is a flowchart of a component group generation process;

FIG. 9 is a flowchart of a work team assignment process;

FIG. 10 is a flowchart of a detailed work plan creation process;

FIG. 11 is a flowchart of an execution sequence determination process;

FIG. 12 is a flowchart of an execution sequence determination process on component-by-component basis;

FIG. 13 is a flowchart of a work space interference check/avoidance process;

FIG. 14 is a flowchart of a detailed work plan revising process;

FIG. 15 is an illustration of an example of a work space of a component;

FIG. 16 is a diagram representing an example of a component group by a tree;

FIG. 17 is a diagram showing work sequential order numbers as a result of assigning a work sequential order number to each component of the component group;

FIG. 18 is an example of a screen display by the work plan creating apparatus;

FIG. 19 is an example of a screen display as a result of generating component groups;

FIG. 20 is an example of a screen display as a result of assigning work teams;

FIG. 21 is an example of a screen display as a result of determining execution sequences of detailed works;

FIG. 22 is an example of a screen display showing a work space interference portion; and

FIG. 23 is an example of a screen display as a result of avoiding the work space interference.

### DETAILED DESCRIPTION OF THE PREFERRED EMBODIMENT

An embodiment for carrying out the present invention will be described in detail below with reference to the drawings, as appropriate. An example of plant construction will be described below, however, application of the invention is not limited to plant construction, and the invention also can be applied to construction of a large scale structure, such as a building or a bridge, or manufacturing a large scale assembled structure, such as an aircraft, a train, or the like.

### [System Configuration]

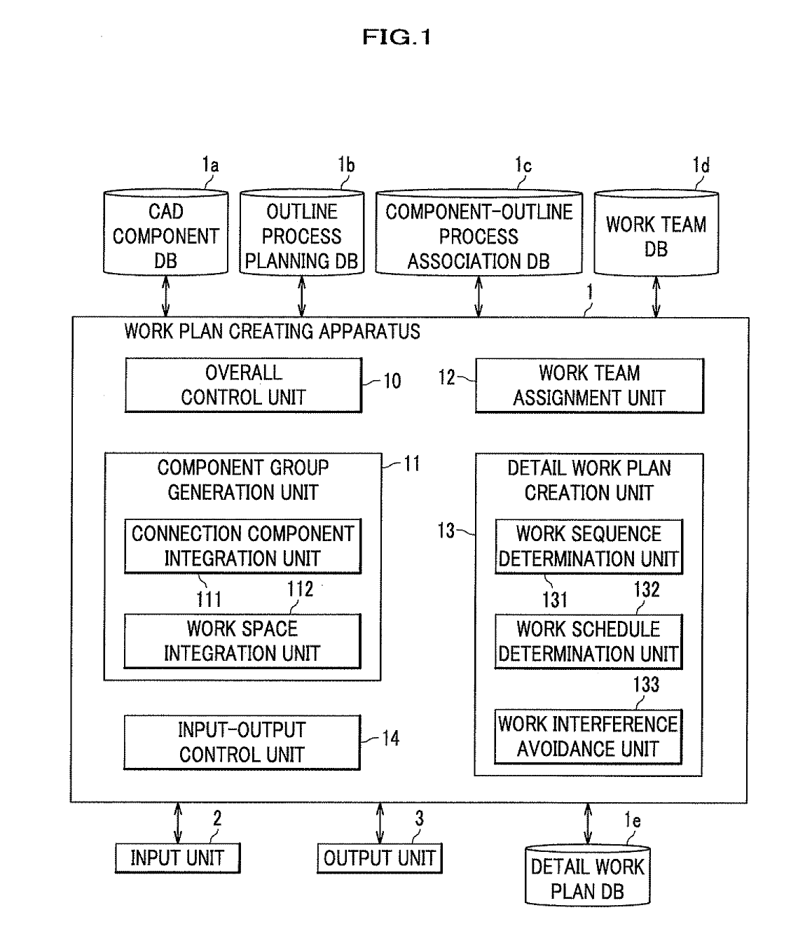

FIG. 1 is a function block diagram showing an example of the entire configuration of a work plan creating system in an embodiment (hereinafter, referred to as ‘the present embodiment’) for carrying out the invention. As shown in FIG. 1, a work plan creating system in the present embodiment includes a work plan creating apparatus 1, an input device 2, and an output device 3. The work plan creating apparatus 1 includes, for example, a personal computer. With input operation via the input device 2, such as a mouse, a keyboard, and the like, the work plan creating apparatus 1 uses various data registered in a CAD component DB (database) 1a, a work team DB 1d, a component-outline process association DB 1c, and an outline process planning DB 1b. Thus, the work plan creating apparatus 1 develops a given outline process plan into works on component-by-component basis to create detailed work plans, outputs a result of the creation to a detailed work plan DB 1e, displays the result on the output device 3, such as a liquid crystal display, and thereby aids making detailed work plans.

### [Data Structure]

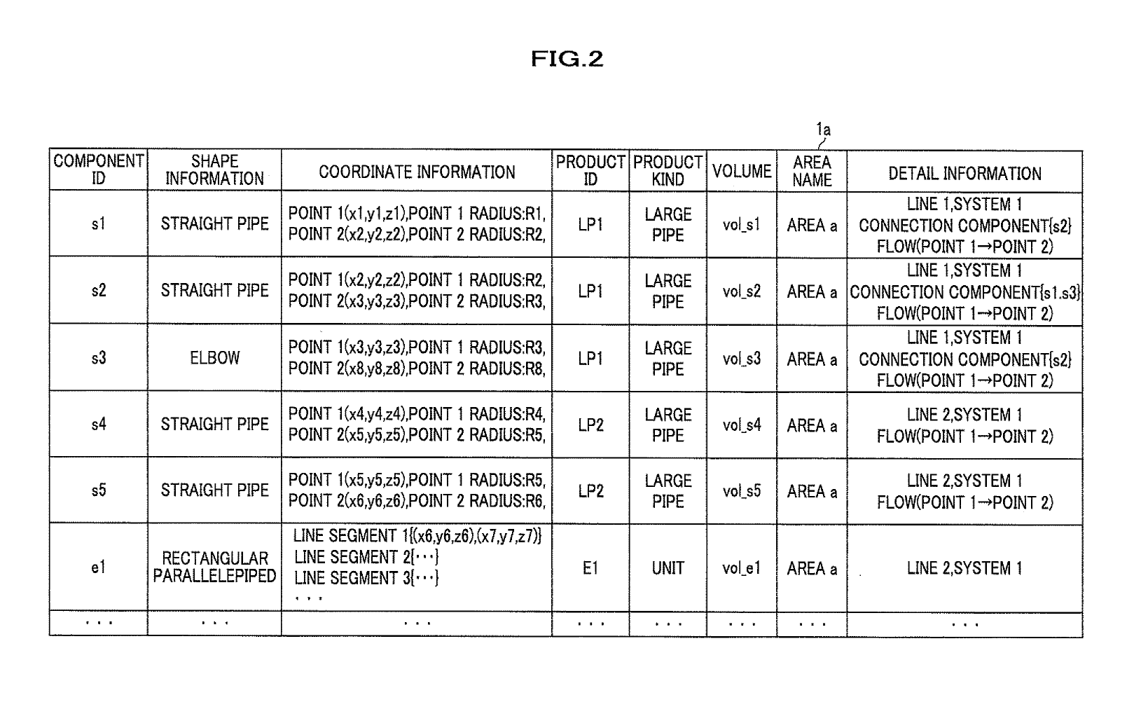

First, examples of the data structures and the data of the databases 1a to 1e will be described below with reference to FIGS. 2 to 6.

### [CAD Component DB]

FIG. 2 shows an example of the data structure and the data of the CAD component DB 1a. As shown in FIG. 2, records are registered in the CAD component DB 1a for individual components for construction of a plant. In each record, stored are a component ID (identification), shape information, coordinate information, a product ID, a component kind, a volume, an area name, detailed information, and the like.

Herein, component IDs refer to identifications formed by a text string and the like for uniquely identifying individual components, and are hereinafter abbreviated as s1, s2, . . . for brevity. Shape information represents the shapes of components including, for example, straight pipes/elbows/rectangular parallelepipeds. Coordinate information represents spatial positions of components in respective work areas, and includes, for example, information on the center coordinates and the radius forming the two end surfaces (for example the top surface and the bottom surface) in a case of a straight pipe/elbow, and information on twelve line segments (Information on line segments is given as the coordinates of two points.) in a case of a rectangular parallelepiped. Product IDs refer to identifications that uniquely identify products to which components belong (grouped). Product IDs will be abbreviated below for brevity as LP1, LP2, . . . in case that products are large pipes, and E1, E2, . . . in case that products are equipment units.

Component kinds represent the kinds of components, such as, large pipe, equipment unit, and the like. Volumes represent the volumes of components, and are actually expressed by numerical values representing volumes. Volumes will be abbreviated for brevity as vol_1, vol_2, . . . , etc. Area names refer to the names of work areas to which components belong (installed), for example, a text string ‘turbine building/second basement/area 23’, and will be abbreviated for brevity as area a, area b, . . . , etc. Detailed information represents other detailed information related to components, and includes, for example, line numbers and system numbers to which products belong, component IDs of connection components to be connected, and the like. Incidentally, like the example in FIG. 2, for pipe components, information on flow that represents the direction of a fluid that flows inside pipes during operation may be included.

### [Outline Process Planning DB]

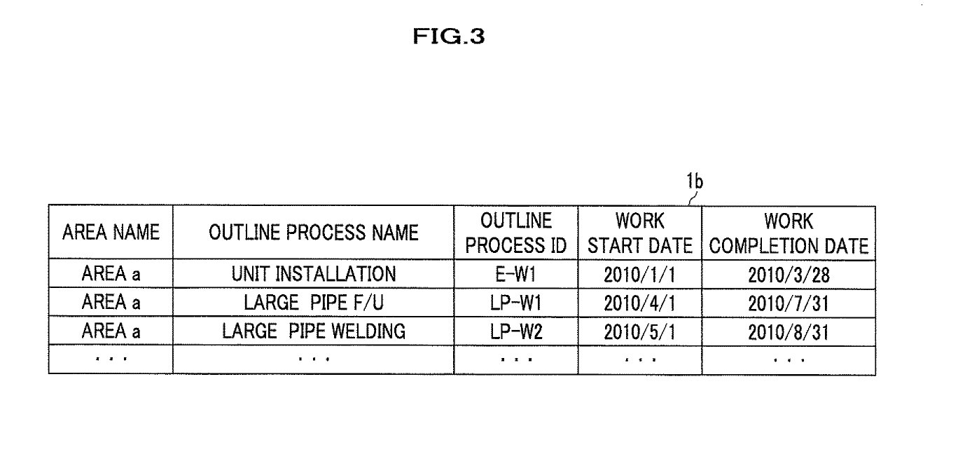

FIG. 3 shows an example of the data structure and the data of the outline process planning DB 1b. As shown in FIG. 3, a plurality of records are registered on outline process-by-outline process basis in the outline process planning DB 1b, the outline processes being included in the outline process plan. In each of the records, stored are an area name, an outline process name, an outline process ID, a work start date, a work completion date, and the like.

Area names refer to the names of work areas where the works of the corresponding outline processes are executed, and have the same values (abbreviated as area 1, area b, . . . , and the like) as those of the area names in the CAD component DB 1a. Outline process names refer to the names of outline processes described in process charts and the like. Outline process names are text strings, for example, ‘large pipe F/U (fit up)’. Outline process IDs refer to identifications assigned to uniquely identify outline processes included in the outline process plan. For example, to outline processes with an outline process name ‘equipment unit installation’, a series of outline process IDs, such as E-W1, E-W2, . . . , are assigned, and to outline processes with an outline process name ‘large pipe F/U’, a series of outline process IDs, such as LP-W1, LP-W2, . . . , are assigned. Work start dates refer to dates of starting outline processes, and work completion dates refer to dates of completion of the corresponding outline processes, for example, ‘2010/01/01’ (year/month/date).

The example of data in FIG. 3 shows a case that, in an outline process where work is executed in a work area with an area name ‘area a’, three outline processes with outline process IDs of E-W1, LP-W1, and LP-W2 are present, and the respective work start dates and the respective work completion dates are set such as to execute these three outline processes in this sequence.

In such a manner, work start dates and work completion dates are given in the outline process planning DB 1b to respective outline processes having been determined corresponding to the respective kinds of components. For example, as outline processes corresponding to component groups with a component kind ‘large pipe’, specified are large pipe F/U (outline process ID: LP-W1) and large pipe welding (outline process ID: LP-W2), and the respective work start dates and work completion dates are set. Herein, these work start dates and work completion dates are set for the entire work periods of respective component groups with the same component kind, and do not specify the work sequence nor the work dates of individual components.

### [Component-Outline Process Association DB]

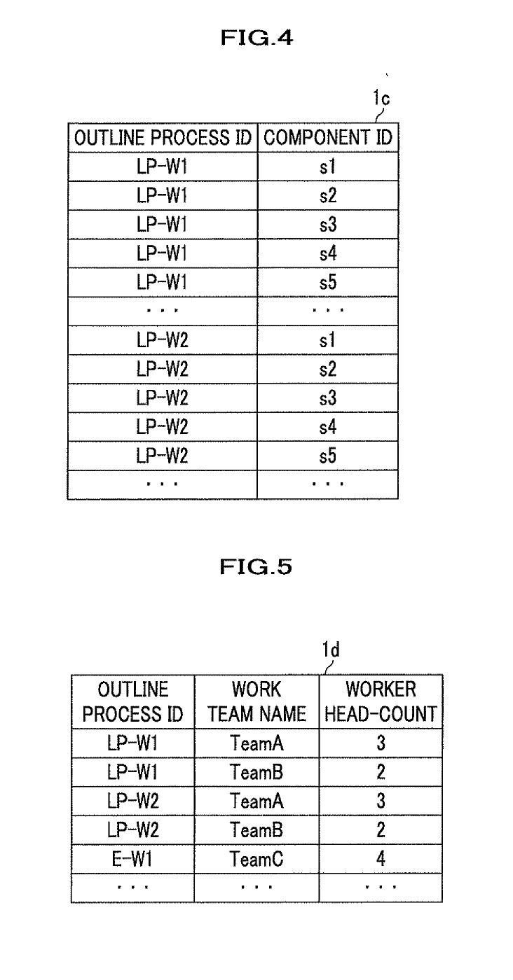

FIG. 4 shows an example of the data structure and the data of a component-outline process association DB 1c. As shown in FIG. 4, in the component-outline process association DB 1c, a plurality of records are registered on pair-by-pair basis, each pair being a pair of an individual outline process included in the outline process plan and a component subjected to work in the outline process, wherein an outline process ID and a component ID are stored in each record.

Outline process IDs refer to identifications for uniquely identifying respective outline processes included in the outline process planning DB 1b, and have the same values as those of the outline process IDs in the outline process planning DB lb. Component IDs refer to component IDs of components subjected to work in a corresponding outline process, and have the same values as those of the component IDs in the CAD component DB 1a.

The example of data in FIG. 4 shows a case that components subjected to work in the outline process with an outline process ID of LP-W1 are five components with component IDs s1-s5, and components subjected to work in the outline process with an outline process ID of LP-W2 are also five components with component IDs s1-s5.

### [Work Team DB]

FIG. 5 shows an example of the data structure and the data of the work team DB 1d. As shown in FIG. 5, in the work team DB 1d, a plurality of records are registered on pair-by-pair basis, each pair being a pair of an individual outline process included in the outline process plan and a work team in charge of works in the outline process, wherein an outline process ID, a work team name, and a worker head-count are stored in each record.

Outline process IDs refer to identifications for uniquely identify respective outline processes included in the outline process plan, and have the same values as those of the outline process IDs in the outline process planning DB 1b. Work team names refer to the names of work teams assigned to corresponding outline processes in the outline process plan. At least one work team is assigned to each outline process. In an outline process to which two or more work teams are simultaneously assigned, different records are registered for the respective work teams. A worker head-count refers to the number of workers who belong to the corresponding work team.

Thus, work teams in charge of each outline process and the worker head-counts of the work teams are recognized. Incidentally, like the case of Team A or Team B in the example of data in FIG. 5, the same team may be assigned to a plurality of outline processes. In this case, different records are registered for the respective outline processes to which the same team is assigned.

The example of data in FIG. 5 shows a case that Team A with 3 workers and Team B with 2 workers are respectively assigned to an outline process with an outline process ID of LP-W1 and an outline process with an outline process ID of LP-W2, and Team C with 4 workers is assigned to an outline process with an outline process ID of E-W1.

### [Detailed Work Plan DB]

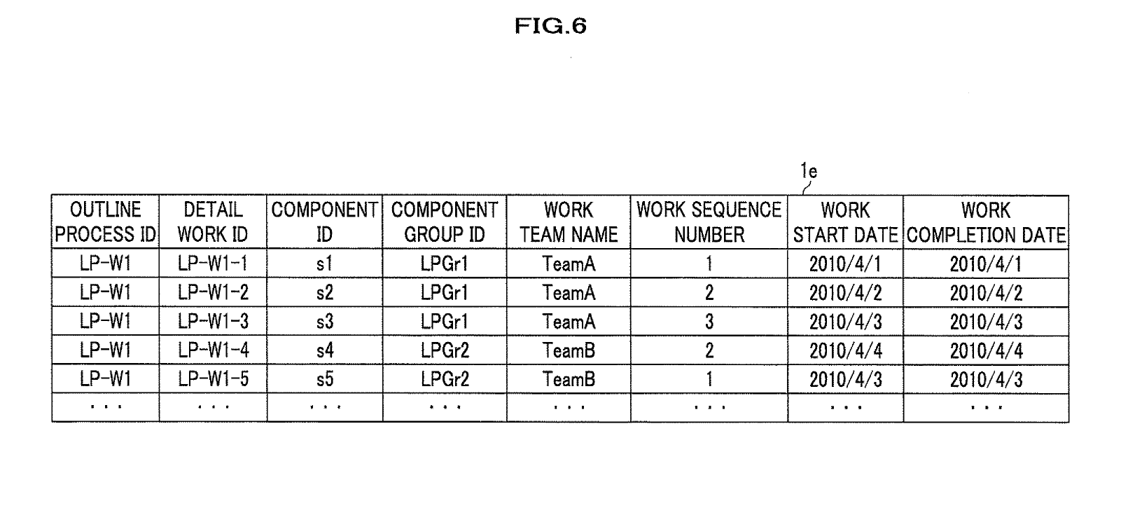

FIG. 6 shows an example of the data structure and the data of the detailed work plan DB 1e. As shown in FIG. 6, in the detailed work plan DB 1e, a plurality of records are registered on detailed work-by-detailed work basis, and detailed works herein refers to detailed works which are on component-by-component basis. In each record, stored are an outline process ID, a detailed work ID, a component ID, a component group ID, a work team name, a work sequential order number, a work start date, a work completion date, and the like.

Outline process IDs refer to the outline process IDs of outline processes that include corresponding detailed works, and have the same values as those of outline process IDs in the outline process planning DB 1b. Detailed work IDs refer to identifications to uniquely identify respective detailed works. A detailed work ID is generated from the data of an outline process ID and the data of a component ID, and is a text string, for example, LP-W1-1, LP-W1-2, . . . , or the like. A component ID refers to the component ID of a component to be an object of a corresponding detailed work, and has the same value as that of a component ID in the CAD component DB 1a. A component group ID refers to an identification, of a component group, that is generated and given by a component group generation unit 11, and is a certain text string, for example, LPGr1, LPGr2, . . . , or the like. A work team name refers to the name of a work team that executes corresponding detailed works, and has the same value as that of a work team name in the work team DB 1d. A work sequential order number refers to a serial number that is determined by a work sequence determination unit 131 (FIG. 1) and represents the work sequential order of a corresponding detailed work. A work start date is a date of starting a detailed work, and a work completion date is a date of completing the detailed work. Both are data of a date, for example ‘2010/04/01 (year/month/date). Incidentally, for a detailed work to be completed in one day, the work start date and the work completion date are the same date.

In each record in the detailed work plan DB 1e, registration is first performed by the component group generation unit 11, and three kinds of data, namely an outline process ID, a component ID, and a component group ID are first stored. Then, the data of a work team name is stored by a work team assignment unit 12 (FIG. 1), and finally thereafter, four kinds of data, namely an detail work ID, a work sequential order number, a work start date, and a work completion date are stored by the detailed work plan creation unit 13 (FIG. 1).

### [Configuration and Functions of Work Plan Creating Apparatus]

The configuration and functions of the work plan creating apparatus 1 will be described below. The work plan creating apparatus 1 in the preset embodiment is configured with a computer on which respective functions are implemented in such a manner that a processing unit, not shown, having a CPU (central processing unit) and a memory, loads a program, which is stored in a storage unit, not shown, onto the memory and executes the program. As shown in FIG. 1, the work plan creating apparatus 1 includes function units, namely an overall control unit 10, a component group generation unit 11, a work team assignment unit 12, a detailed work plan creating unit 13, and an input/output control unit 14.

The overall control unit 10 has a function to control the overall operation of the apparatus.

The component group generation unit 11 has functions to read out the data of components from the CAD component DB 1a, and to group individual components, which are included (to be installed) in the corresponding same work area, into several component groups, according to component kinds or connection relationships between components. The component group generation unit 11 includes a connection component integration unit 111 for generation of a component group by grouping components to be connected with each other among components of the same component kind, and a work space integration unit 112 for grouping, among component groups of the same component kind, component groups which have a ratio of overlapping of respective work spaces with each other, the ratio being larger than or equal to a predetermined value, into one component group. As a result, in case that a plurality of component groups with the same component kind are generated, these component groups have small work spaces overlapping with each other. Consequently, it is understood that works can be executed in parallel.

The work team assignment unit 12 has a functions to obtain the data of work teams assigned to respective outline processes from the work team DB 1d; read out the design data of necessary components from the CAD component DB 1a, referring to the component-outline process association DB 1c; and assign the respective component groups having been grouped by the component group generation unit 11 to one or more work teams such that the work amounts of the respective work teams are averaged. As a result, in case that a plurality of component groups included in the same outline process are assigned to work teams different from each other, these component groups can be executed in parallel.

A detailed work plan creation unit 13 includes a work sequence determination unit 131, a work schedule determination unit 132, and a work interference avoidance unit 133. As functions to be applied to each component group which has been assigned to a work team by the work team assignment unit 12, the detailed work plan creation unit 13 has functions to determine the execution sequence of detailed works on a component-by-component basis included in the component group, and determine the work start date and the work completion date of each detailed work.

The work sequence determination unit 131 determines the execution sequence of works on respective components included in a component group having been assigned to a work team by the work team assignment unit 12, based on predetermined work sequence restriction and work priority rules. A work schedule determination unit 132 determines the work start date and the work completion date of the components whose execution sequence has been determined by the work sequence determination unit 131, based on the amounts of material of the components and the like.

As a result, if two or more detailed works are to be executed in parallel in the same work area, it is possible that work spaces overlap with each other between these detailed works. A work interference avoidance unit 133 has a function to check, among detailed works whose work start date and work completion dates have been determined by the work schedule determination unit 132, whether or not there are detailed works to be executed in parallel and would cause interference between the works with overlapped work spaces larger than a predetermined space, and a function to revise the execution sequence or the work schedule of the detailed works in order to eliminate interference between works if it would otherwise occur.

The input/output control unit 14 has a function to receive input from the input device 2, upon instruction by the overall control unit 10, and a function to transmit screen data to be displayed on the output device 3.

### [Operation of Work Plan Creating Apparatus]

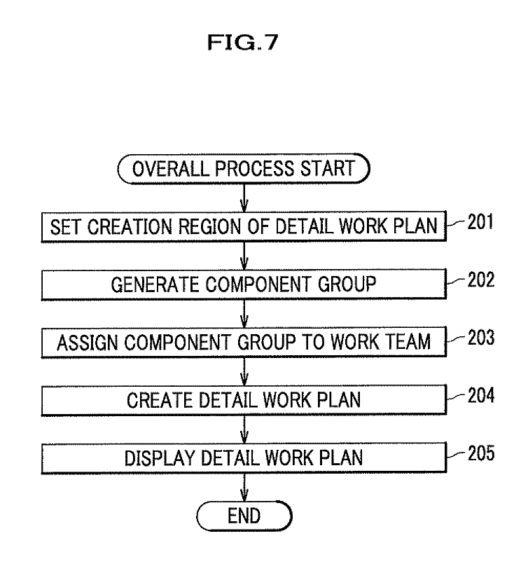

The operation of the work plan creating apparatus 1 will be described below with reference to a flowchart. FIG. 7 is a flowchart showing the flow of the overall operation in automatically creating detailed work plans in a specific work area, using the work plan creating apparatus 1. The operation of the work plan creating apparatus 1 will be described in detail with reference to the flowchart in FIG. 7.

### [Overall Process (Creation Region Setting Process), Process 201 in FIG. 7]

When the work plan creating apparatus 1 (FIG. 1) is started, an overall control unit 10 displays an initial screen, not shown, on the output device 3 via the input/output control unit 14; displays a screen, not shown, for designation of a creation region for detailed work plans on the output device 3, upon input from the input device 2 received via the input/output control unit 14; and receives the input of designation of the creation region for the detailed work plans. This designation of a creation region includes at least designation of a work area to be a creation object of detailed work plans, and may further include designation of an outline process to be developed into detail work plans and a period to be an object.

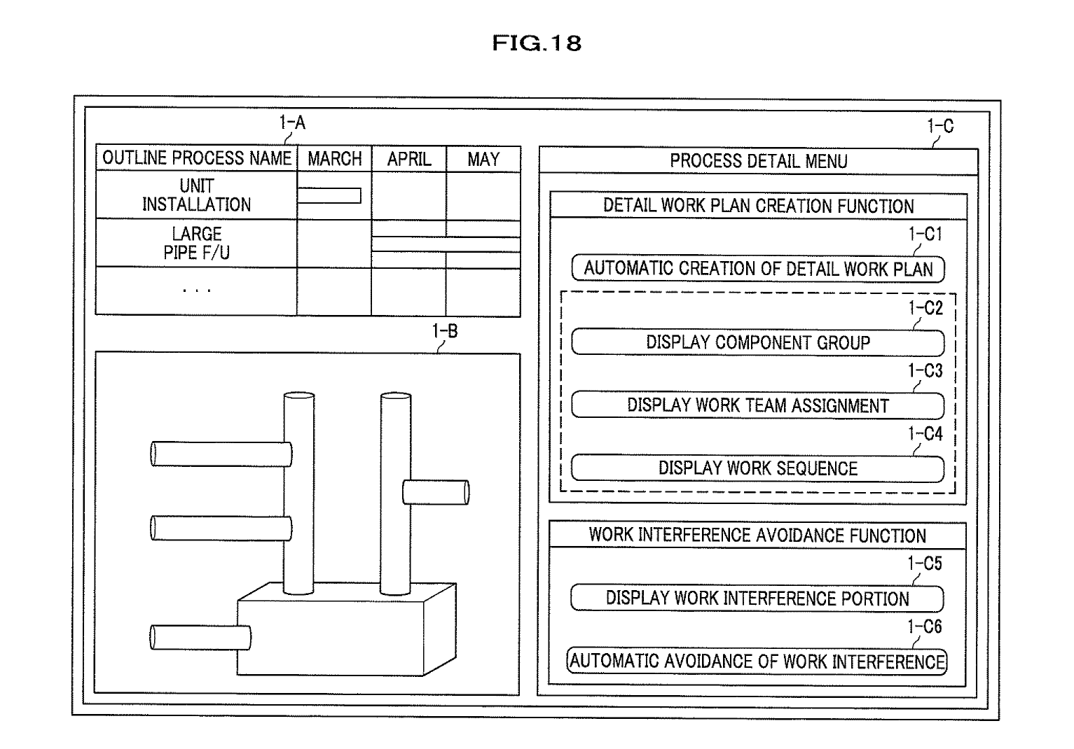

Upon reception of an input of designating a creation region of detailed work plans, the overall control unit 10 sets the creation region of the detailed work plans in a process 201, according to the received designation of a creation region, and displays the data of a portion, corresponding to the set creation region, of the outline process plan on the output device 3. FIG. 18 is an example of a screen displayed then on the output device 3.

As shown in FIG. 18, the screen includes a process chart display section 1-A, a three dimensional figure display section 1-B, and a process detailing menu display section 1-C. The process chart display section 1-A displays, in a certain format, a process chart generated from the data of an outline process plan or detail work plans. The three dimensional figure display section 1-B displays three dimensional figures, of components such as an equipment unit or a pipe, generated from data in the CAD component DB 1a. The process detailing menu display section 1-C is a graphical user interface that provides various functions to create a detailed work plan from an outline process plan, and includes a detailed work plan automatic creation button 1-C1, a component group display button 1-C2, a work team assignment display button 1-C3, a work sequence display button 1-C4, a work interference portion display button 1-C5, and a work interference automatic avoidance button 1-C6.

The detailed work plan automatic creation button 1-C1 automatically creates detailed work plans from an outline process plan, and provides a function to display the created detailed work plans on a screen. The component group display button 1-C2 provides a function to display, on a screen, a result of dividing components included (to be installed) in a designated work area into component groups. The work team assignment display button 1-C3 provides a function to display, on a screen, a result of assigning the component groups to work teams. The work sequence display button 1-C4 provides a function to display, on a screen, the created detailed work plans (before avoidance of work interference).

The work interference portion display button 1-C5 checks presence or absence of works that could cause interference in created detailed work plans, and provides a function to display an interference portion on a screen. Further, the work interference automatic avoidance button 1-C6 provides a function to automatically revise the detailed work plan to avoid work interference if it could occur, and a function to display the revised detailed work plan on a screen.

FIG. 18 shows an example of a screen display when the data of an outline process plan from March to May in a certain designated area is displayed in the process chart display section 1-A and the three dimensional figure display section 1-B. In this screen, then, if the detailed work plan automatic creation button 1-C1 in the process detailing menu display section 1-C is electively input, or if five buttons from the component group display button 1-C2 to the work interference automatic avoidance button 1-C6 are sequentially and selectively input from the top one by one, then the operation from process 202 and after in FIG. 7 is executed.

In the following, on assumption that the detailed work plan automatic creation button 1-C1 is selectively input in the screen shown as an example in FIG. 18, the operation by sequential execution of a series of processes from 202 and after in FIG. 7 will be described below. When the five buttons from the component group display button 1-C2 to the work interference automatic avoidance button 1-C6 are sequentially input one by one from the top, the operation is exactly the same except that intermediate results are displayed on the screen. In more details, a result of execution of process 202 is displayed by the component group display button 1-C2; a result of execution of process 203 is displayed by the work team assignment display button 1-C3; intermediate results of process 204 are displayed by the work sequence display button 1-C4 and the work interference portion display button 1-C5; and a result of execution of process 204 is displayed by the work interference automatic avoidance button 1-C6.

### [Overall Process (Component Group Generation Process), Process 202 in FIG. 7]

In process 202, the overall control unit 10 starts the component group generation unit 11, and the component group generation unit 11 performs grouping of all components included (to be installed) in a corresponding work area to generate component groups. For generation of these component groups, information on, at least, the kinds of respective components and connections between components are used, however, other attribute information also may be used. Other attribute information herein includes, for example, an area number or a system number, however, the attribute information is not particularly limited here because it depends on a system as an object. Incidentally, a component group is generated, based on the kind of components, the positions of components, or the like, which is common to all outline processes.

### [Details of Component Group Generation Process, Process 202 in FIG. 7]

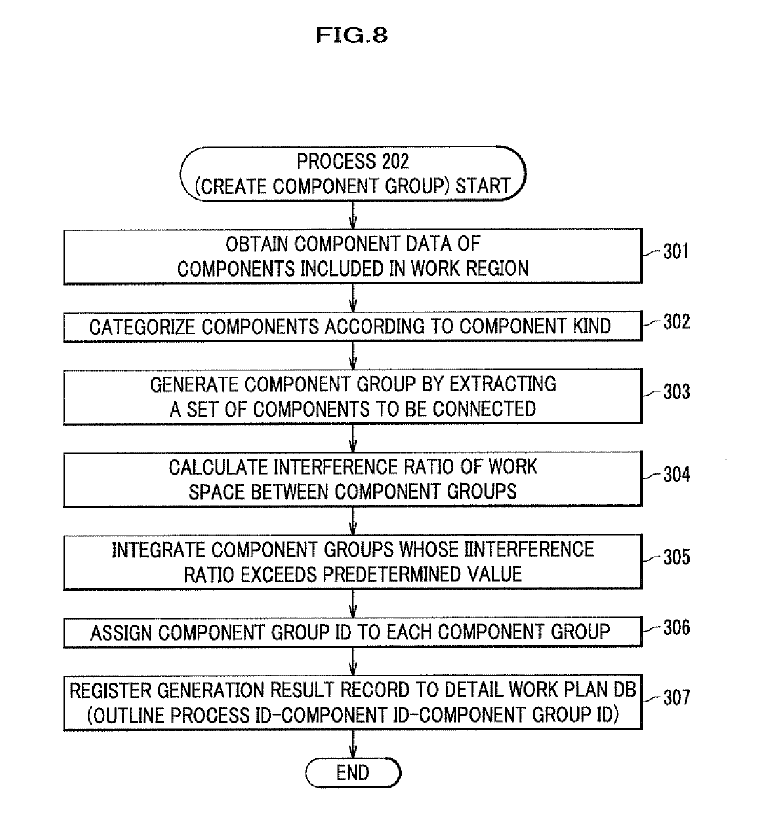

The process of generating component groups (process 202 in FIG. 7) will be further described below with reference to FIG. 8.

The component group generation unit 11, in process 301 first, extracts outline process IDs in a work area corresponding to a creation region having been set from the outline process planning DB 1b, and refers to the component-outline process association DB 1c to obtain the component data of all components included in the corresponding creation region from the CAD component DB 1a.

Subsequently in process 302, the component group generation unit 11 categorizes the obtained component data, according to the kind of component. For example, in a case of a data example in the CAD component DB 1a, shown in FIG. 2, the data is categorized into five records (component ID: s1 to s5) with a component kind ‘large pipe’ and one record (component ID: e1) with a component kind'equipment'. This categorization is made in order to determine the execution sequence of works among components which belong to the same component kind in developing an outline process into detailed work plans on component-by-component basis.

Then, in process 303, the connection component integration unit 111 generates component groups in integration of components to be connected to each other for the respective categorized component kinds, based on the connection relationships between the components. For example, in the case of the data example in the CAD component DB 1a, shown in FIG. 2, among the records of the components s1 to s5 having been categorized as large pipe, it is recognized, with reference to information on connection components in detailed information on the components s1 to s3, that the three components s1, s2, and s3 are to be connected, and recognized, with reference to coordinate information on the components s4 and s5, that these two components are to be connected. Consequently, these two component groups are generated. Further, only the component e1 has a component kind ‘equipment unit’, and no other connection components with this component kind are present.

Consequently, one component group is generated also on the component e1. Thus, totally, three component groups of {s1, s2, s3}, {s4, s5}, and {e1} are to be generated.

Then, in process 304, the work space integration unit 112 computes interference ratios that represent the degrees of overlapping between work spaces, on all component groups with the same component kind among the generated component groups. An interference ratio herein is defined to be the volume ratio of the portion of the work space to the entire work space of a component group, wherein the portion overlaps with the work space of another component group. In the above-described example, the interference ratio between the component group {s1, s2, s3} and the component group {s4, s5} is computed.

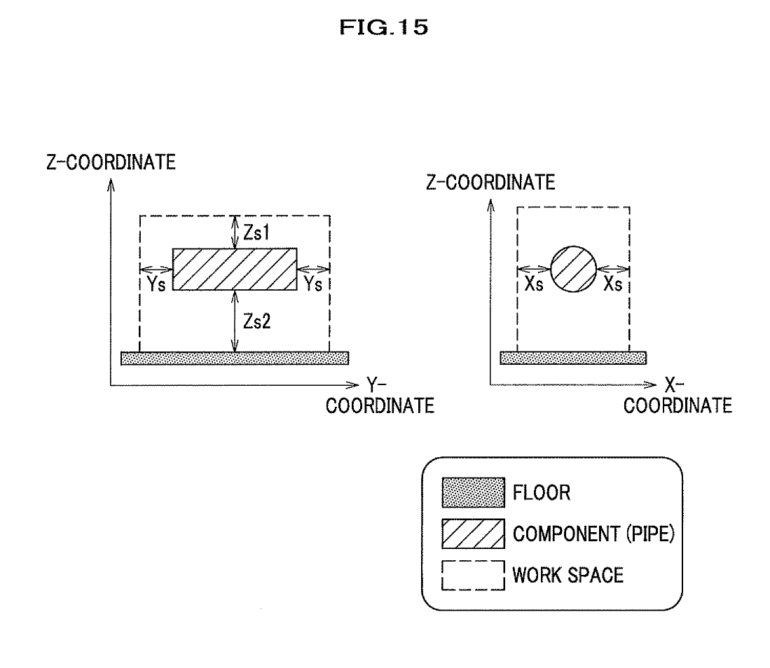

In order to obtain the volume of the overlapping portion of a work space between component groups, the work space of an individual component is first defined. Herein, as shown by dashed lines in FIG. 15, the work space of a component is defined to be a rectangular parallelepiped that covers the periphery of the component and has predetermined widths (for example, Xs=Ys=Zs1=50 cm) along X-axis, Y-axis, and Z-axis, wherein the rectangular parallelepiped is in contact with a floor at the bottom surface thereof (Zs2 refers to the height from the floor to the bottom surface.). The work space of a component group is obtained by connecting the work spaces of all components included in the component group.

The overlapping portion between two work spaces may be obtained in such a manner that data which represent the volumes of the two spaces is set on a graphic memory representing a three dimensional space and it is checked whether or not overlap is present, based on logical AND operation in three dimensions, or in another manner. The volume of an overlapping portion thus obtained is divided by the volume of the original work space, and the interference ratio can be thereby computed. In this manner, interference ratios can be computed on all component groups.

Then, in process 305, if there is a pair of component groups with a computed interference ratio exceeding a predetermined value κ, then the work space integration unit 112 generates a new component group in integration of the two component groups in order to assign the works of these component groups to the same work team. This is performed in order to reduce the processing amount by the work interference avoidance unit 133 by grouping component groups, between which work interference could occur with high possibility, assigning the newly generated component group to one work team, and thus reducing the occurrence of work interference. A predetermined value ε may be set to a fixed value, for example 0.5, or may be designated by a user via the input device 2. If the value of ε is set to zero, then component groups, between which overlap of work spaces is present if any, are to be assigned to the same work team in any case. In reverse, if the value of c is set to 1, individual component groups are to be assigned to work teams without taking into account at all overlap of work spaces.

Then, in process 306, the component group generation unit 11 generates component group IDs of text strings unique to the generated component groups and assigns the component group IDs to the corresponding generated component groups. As component group IDs to be generated, text strings are generated such as to be, for example, ‘LPGr1’ for the component group [symbol] s1, s2, s3 [symbol] , ‘LPGr2’ for the component group [symbol] s4, s5 [symbol] , and ‘EQGr1’ for the component group [symbol] e1 [symbol] .

Finally, in process 307, the component group generation unit 11 registers records, which correspond to a result of generating the component groups, into the detailed work plan DB 1e. Concretely, the component group generation unit 11 generates records that represent the association between outline process IDs, component IDs, and component group IDs, in the number of pairs of a component and an outline process, and additionally registers the respective generated records into the detailed work plan DB 1e. Thus, in case that the records of a plurality of outline processes are registered for the same component in the component-outline process association DB 1c, different records are to be generated and registered for the respective outline processes.

### [Overall Process (Work Team Assignment Process), Process 203 in FIG. 7]

Description will be continued returning to FIG. 7. Then, in process 203, the overall control unit 10 starts the work team assignment unit 12, and the work team assignment unit 12 assigns each of the generated component groups to one or more work teams. This is performed such that the amount of material of component assigned per worker is averaged to a certain extent for respective component kinds. Herein, the volumes of components registered in the CAD component DB 1a may be used for the amounts of material of components, and in case that the volumes of components are not registered, the number of components may be used instead.

### [Details of Work Team Assignment Process, Process 203 in FIG. 7]

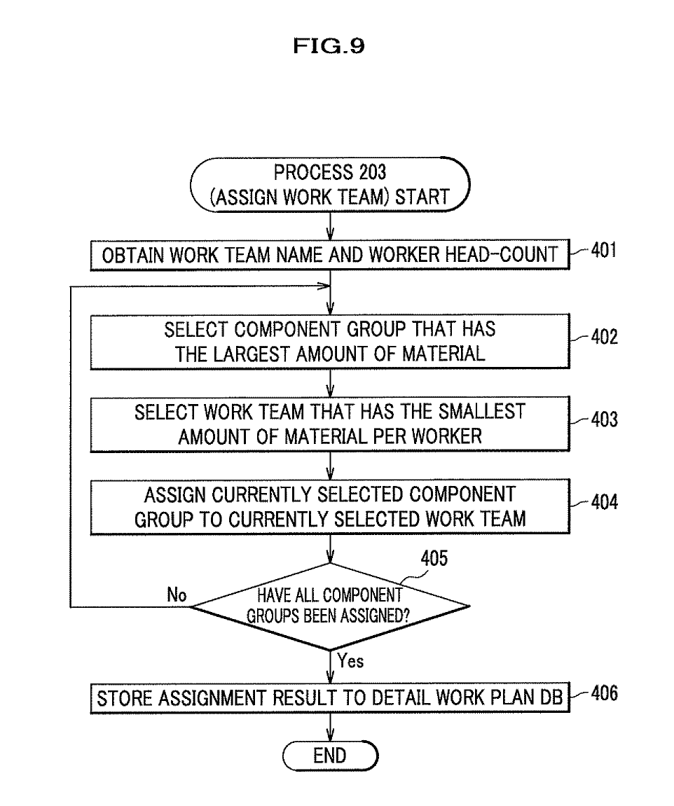

The process (process 203 in FIG. 7) of assigning component groups to work teams will be described in further detail with reference to FIG. 9.

The work team assignment unit 12, in process 401 first, obtains work team names as objects of assignment and worker head-counts from the work team DB 1d, and in subsequent processes 402 to 405, assigns one or more work teams to each component group.

In process 402, the work team assignment unit 12 selects one component group with the largest amount of material from component groups to which no work team has been assigned yet. That is, a component group, whose total amount of material of components included in the component group is the largest, is selected. This is because work teams are assigned to component groups in decreasing order of the amount of material of a component group.

Then, in process 403, from work teams that are in charge of an outline process related to a corresponding component group, the work team assignment unit 12 selects one work team whose amount of material per worker becomes the smallest when the corresponding component group is assigned. By computing then the amount of material per worker for respective component kinds, the amount of material per worker to be assigned to respective work teams can be averaged to a certain extent for respective component kinds.

Then, in process 404, the work team assignment unit 12 assigns a currently selected component group to a currently selected work team. However, in the event that, as a result, the amount of material per worker of the work team to which the component group has been assigned exceeds a predetermined reference value, the work team assignment unit 12 assigns the amount of material of exceeding deviation from the reference value to another work team.

Then, in process 405, the work team assignment unit 12 determines whether all component groups have been assigned to work teams. If there are component groups having not been assigned yet, the work team assignment unit 12 returns to process 402 (branching to No in process 405) to execute the above-described process on the subsequent component group. Further, if all component groups have been assigned, the work team assignment unit 12 stores, in process 406 (branching to Yes in process 405), a result of assignment of work teams in the work team names of respective records in the detailed work plan DB 1e, and then terminates the process. Incidentally, in case of having assigned one component group to a plurality of work teams, the work team assignment unit 12 generates and registers different records for the respective work teams.

### [Overall Process (Detailed Work Plan Creation Process), Process 204 in FIG. 7]

Herein, returning to FIG. 7, description will be continued. Then, in process 204, the overall control unit 10 starts the detail work plan creating unit 13, and based on the above-described result of assigning work teams, the detail work plan creating unit 13 determines the execution sequences and the work schedules of the detailed works of the respective work teams on a component-by-component basis, and thus creates detailed work plans.

### [Details of Detailed Work Plan Creation Process, Process 204 in FIG. 7]

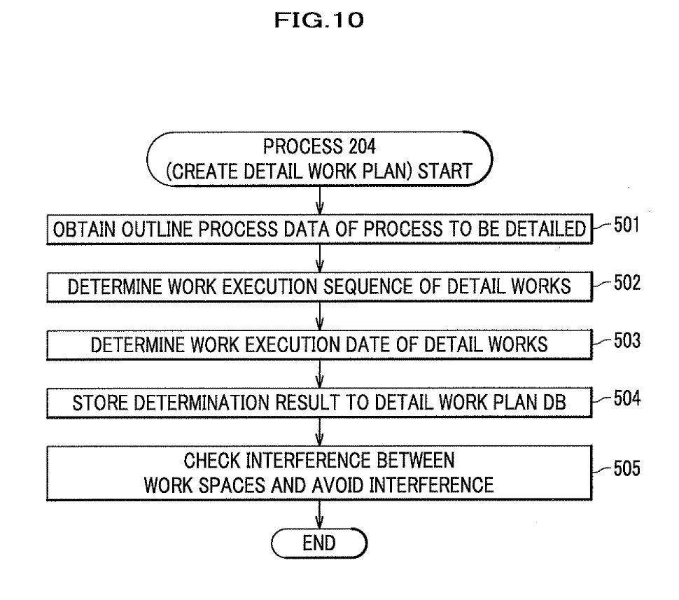

Herein, with reference to FIG. 10, a process of creating detailed work plans (process 204 in FIG. 7) will be described in more details.

The detail work plan creating unit 13, in process 501 first, obtains the data of the outline processes to be detailed which correspond to the creation region, designated in process 201 in FIG. 7, for detailed work plans, from the outline process planning DB 1b. Then, in process 502, the work sequence determination unit 131 determines the execution sequence of detailed works on component-by-component basis, for the respective outline processes.

### [Execution Sequence Determination Process on Detailed Works, Process 502 in FIG. 10]

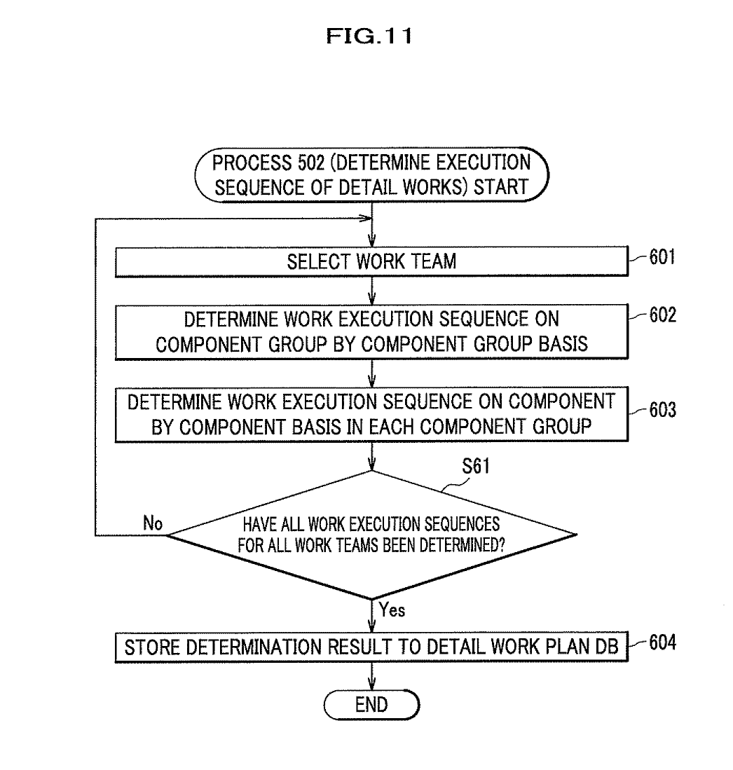

Herein, with reference to FIG. 11, a process of determining the execution sequences of detailed works (process 502 in FIG. 10) will be described in more details.

The work sequence determination unit 131, in process 601 first, selects one work team whose execution sequences of detailed works have not yet been determined. Then, in process 602, the work sequence determination unit 131 determines the work execution sequences on component group-by-component group basis on respective component kinds, based on the work priority rules, for all component groups assigned to the selected work team. Subsequently, in process 603, the work sequence determination unit 131 determines the work execution sequences component-by-component basis on components included in each same component group, based on the work priority rules and the work procedure restriction.

Herein, the work execution sequences are determined for respective component kinds because the outline process plan is originally made such that outline processes are originally divided corresponding to respective component kinds, and accordingly, the execution sequence of each detailed work can be determined between components of the same component kind included in the same outline process.

Then, in process S61, the work sequence determination unit 131 determines whether the execution sequences of works of all work teams have been determined, and if there are work teams on which work execution sequences have not been determined, the work sequence determination unit 131 returns to process 601 (branching to No in process S61) to perform a process, which is similar to the above, on the subsequent work team. By repeating these processes until the result of determination in process S61 becomes Yes, after determining the execution sequences of detailed works of all work teams and then determining the execution sequences of the works of all the work teams, the work sequence determination unit 131 stores, in process 604 (branching to Yes in process S61), the results of determination to the work sequential numbers of the respective corresponding records in the detailed work plan DB 1e.

### (Work Priority Rules)

The work priority rules will be described below. The work priority rules include a rule for determining the execution sequence of works on component group-by-component group basis, and a rule for determining the execution sequence of works on component-by-component basis in a component group.

According to the work priority rule for determining the execution sequence of works on component group-by-component group basis, in case, for example, of using the height from a floor, it is possible to determine the execution sequence such as to execute works in decreasing or increasing order of the total of the heights of individual components included each component group. Otherwise, the average value of the heights of individual components may be used instead of the total of heights. Further, instead of height, another index, such as the distance from a wall, may be used, and it is also possible to use a plurality of indexes in combination.

According to the rule for determining the execution sequence of works on component-by-component basis of individual components in a component group, it is likewise possible, for example, to determine the execution sequence such as to execute works in a decreasing order of the height from the floor or in an increasing order of the distance from the wall, based on the positions of components. Otherwise, works may be executed in a decreasing order of the component volume. Further, being limited to component groups with a component kind of pipe, works may be executed in a decreasing order of pipe diameter, and may be executed in the path sequence of a fluid flowing in pipes in operation of a plant. Otherwise, works may be executed in sequences reverse to the above sequences.

Respective data necessary for computation of these indexes can be obtained from the CAD component DB 1a (FIG. 2). For example, the height of a component from the floor can be obtained by computing the smallest z-coordinate value from the coordinate information of an object component, extracting the largest z-coordinate value from the coordinate information of respective components with a component kind ‘floor’, and obtaining the difference between the above-described two z-coordinate values. Further, the distance of a component from the wall can be obtained, for example, by disposing an object component and components with a component kind ‘wall’ on a graphic memory representing a three-dimensional space, projecting the component onto X-Y plane to measure the distance, and thereby extracting the smallest distance to a wall. Further, the diameters of pipes and the path of a fluid can be obtained from coordinate information and detailed information in the CAD component DB 1a.

### (Work Procedure Restriction)

Work procedure restriction will be described below. Work procedure restriction refers to restriction wherein, in order to execute the work on a component, the work on at least one of all connection components (including the floor, the wall, and the ceiling) to be connected to the component must have been completed. Every connection component is recognized by referring to the connection component ID registered in the coordinate information or the detailed information in the CAD component DB 1a, and if the work completion date of the connection component is registered in the detailed work plan DB 1e, the work procedure restriction is satisfied after the work completion date.

### [Process of Determining Work Procedure in Component Group, Process 603 in FIG. 11]

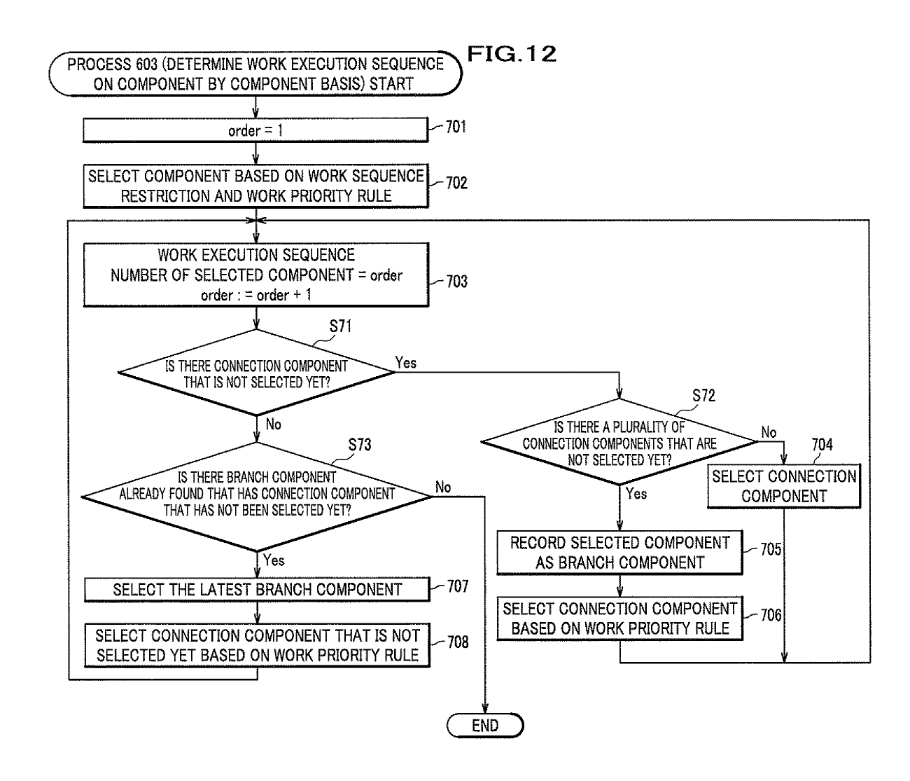

The process (process 603 in FIG. 11), executed by the work sequence determination unit 131, of determining the execution sequence of works on component-by-component basis in a component group will be described below in more details with reference to FIG. 12.

First, the value of order, which is a variable representing a work sequential order number, is initially set to ‘1’ (process 701). Then, a component with which work execution starts is selected, based on the work procedure restriction and the work priority rule (process 702). Concretely, from components that satisfy the work procedure restriction, the most prioritized component is selected, according to the work priority rule.

Herein, a component that satisfies the work procedure restriction is assumed to be either a component to be positioned at an end of a work area (to be connected to the floor, the wall, or the ceiling) or a component with any connection component in a work completion state. Whether or not the latter condition is satisfied can be determined concretely by whether or not the work completion date of the detailed work of any connection component or the work completion date of the outline process corresponding to the component kind of any connection component is before the work start date of the outline process corresponding to the component kind of the selected component. If a plurality of components that satisfy the work procedure restriction are present then, one component that is the most prioritized component is selected, according to the above-described work priority rule. For example, first having the index be the volume, second having the index be the height of the component position, and third having the index be the component ID, a component whose value of the index is the largest or the smallest is selected.

Then, the value of variable ‘order’ is substituted for the work sequence number of the selected component so as to assign a work sequence number, and the value of the variable ‘order’ is increased by 1 (process 703). Then, it is confirmed whether or not a connection component, which has not been selected yet, of the selected component is present (process S71). The fact that a connection component has not been selected yet is determined by the fact that a work sequence number has not been set yet for the record of the component in the detailed work plan DB 1e. As a result, if a connection component having not been selected yet is present (branching to Yes in process S71), then it is confirmed whether or not a plurality of connection components having not been selected yet are present (process S72). As a result, if a plurality of connection components having not been selected yet are not present, in other words, if only one neighboring component is present (branching to No in process S72), this connection component is selected (process 704). On the other hand, if a plurality of connection components having not been selected yet are present (branching to Yes in process S72), then first, the currently selected component is recorded in the memory as a branch component (process 705), and one connection component, namely the most prioritized connection component is selected, according to the work priority rule (process 706). Subsequently, the operation returns to process 703.

If no connection component having not been selected yet is present in process S71 (branching to No in S71), then it is confirmed whether there are connection components having not been selected yet among already-found (recorded in the memory) branch components (process S73). As a result, if there are connection components having not been selected yet (branching to Yes in process S73), then the latest (lastly found) branch component is selected from them (process 707), and then one component is selected from the connection components having not been selected yet of this branch component, according to the work priority rule (process 708). Then, the process returns to process 703. On the other hand, if there is no connection component having not been selected yet (branching to No in process S73), it is confirmed that the work sequence numbers of all components in the component group have been determined, and accordingly the process is terminated.

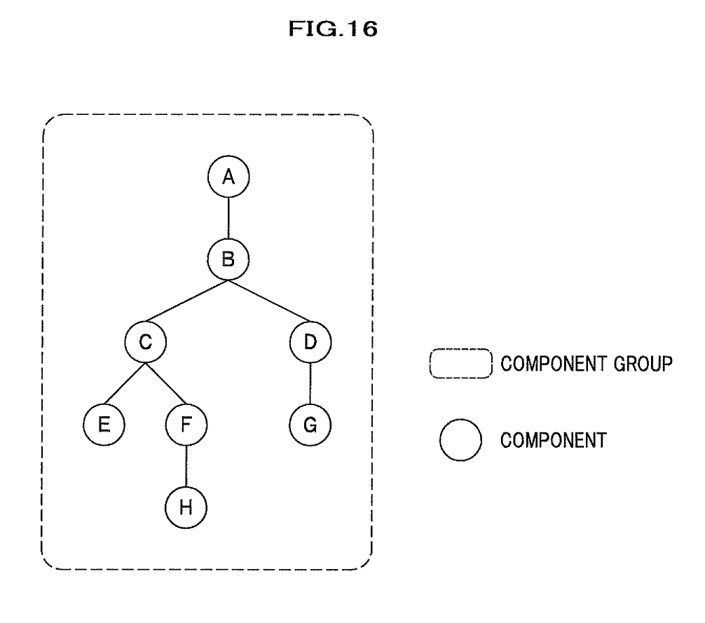

### [Example of Determining Execution Sequence Order, Using Tree, FIG. 16]

FIG. 16 shows an example, representing by a tree, of the structure of a component group for illustration of a procedure that determines work sequence numbers by a process (FIG. 12) of determining the execution sequence order of works on component-by-component basis in the above-described component group.

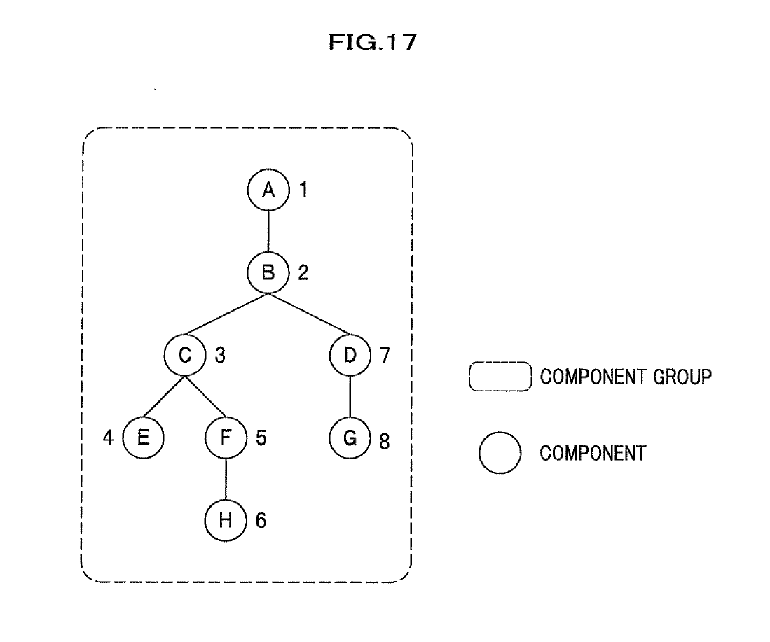

In FIG. 16, nodes A to H, with a character in a circle, represent respective components that form one component group shown by the dashed frame, wherein the respective edges connecting nodes represent the connection relationships between the components. For example, if the components are pipe spools, the edges represent welding spots. As shown in FIG. 16, in case that a component group is represented by a tree, the procedure of determining work sequence numbers, shown in FIG. 12, corresponds to assigning serial numbers, as shown in FIG. 17, to the respective nodes by depth prioritized search, starting with node A, which is the root of the tree.

First, in process 701, the value of the variable ‘order’ representing a work sequence number is set to the initial value ‘1’, and in process 702, one component that is the most prioritized component satisfying the work sequence restriction is selected from components forming a component group as an object. Herein, the selected component is assumed to be node A in FIG. 16.

Then, in process 703, the first work sequence number is assigned to the selected component. This corresponds to assigning number ‘1’ to node A in FIG. 16. Further, subsequently to assigning the work sequence number, the value of the variable ‘order’ is increased by 1. The work sequence number to be assigned next is thereby set to ‘2’.

Then, in process S71, it is determined whether or not a connection component having not been selected yet (in other words, to which a work sequence number having not been assigned yet) is present. This corresponds to determining whether an edge having not been sought yet is present on node A. As a result, an edge on node B is present, and accordingly, as a connection component having not been selected yet is present, the process branches to process S72 (branching to Yes in process S71).

Then, in process S72, it is determined whether or not a plurality of connection components having not been selected yet are present. This corresponds to determining whether a plurality of edges having not been sought yet are present on node A in FIG. 16. As a result, only one edge is present, and as plural connection components are not present, the process branches to process 704 (branching to No in process S72).

Then, in process 704, the only one connection component is selected. This corresponds to searching node B, tracing the edge from node A. Then, the process returns to process 703. Then, in process 703, when the process proceeds to process S72 after assigning a work sequence number ‘2’ to a component corresponding to node B, the process branches to process 705 (branching to Yes in process S72) because two connection components corresponding to node C and node D are now present.

Then, in process 705, the component in current selection corresponding to node B is recorded as a branch component. That is, the component ID of the component in current selection is stored in a stack or the like for recording a branch component.

Then, in process 706, the most prioritized one component is selected from a plurality of connection components having not been selected yet, according to the work priority rule. On the tree in FIG. 16, if it is assumed that respective nodes are disposed such that the closer to the left end a node is, the higher the priority is, then a component corresponding to node C is thereby selected.

Then, the process again returns to process 703, likewise assigns a work sequence number ‘3’ to the component corresponding to node C, and then proceeds to process S72. As two connection components corresponding to node E and node F are present herein also for the component corresponding to node C, the component corresponding to node C is recorded similarly to the above as a branch component, and then the component corresponding to node E is selected.

Then, the process again returns to process 703, likewise assigns a work sequence number ‘4’ to the component corresponding to node E, and then proceeds to process S71. This time, as node E is the deepest node and no connection component having not been selected yet is present for the component corresponding to node E, the process branches to process S73 (branching to No in process S71).

Then, in process S73, it is determined whether there is a branch component that has a connection component having not been selected yet, among the recorded already-found branch components. On the tree in FIG. 16, the already-found branch components correspond to node B and node C, and have edges being respectively connected with node D and node F and having not been sought yet, in other words, have connection components having not been selected yet. Accordingly, the process branches to process 707 (branching to Yes in process S73).

Then, in process 707, the latest branch component, namely, the branch component having been lastly found and recorded is selected. Thus, from the components corresponding to node B and node C, the component corresponding to node C that is the closest to the node E is selected. This corresponds to the procedure of depth prioritized search in the graph.

Then, in process 708, from connection components having not been selected yet and corresponding to node C, which is a component having been selected, one component is selected, according to the work priority rule. This corresponds to selecting the component corresponding to node F in FIG. 16.

Hereinafter, the above-described process is likewise repeated, and a work sequence number is thereby assigned to each component while the work sequence number is increased by 1. Upon completion of assignment of a work sequence number to each of all the components forming the component group, determination in process S73 results in No, and the process is accordingly terminated.

FIG. 17 shows work sequence numbers assigned to each component in the component group, represented by the tree in FIG. 16, by the above-described process.

### [Determination of Execution Dates of Detailed Works, Process 503 in FIG. 10]

Returning again to FIG. 10, description of process 204 (creation of detailed work plans) will be continued.

Then, in process 503, the work schedule determination unit 132 creates detailed work plans by determining the work start dates and the work completion dates of respective detailed works, based on the data, obtained in process 501, of the outline process, and the execution sequences, determined in process 502, of the detailed works.

Herein, the work schedule determination unit 132 determines the schedules of the respective detailed works, based on at least the work start dates and the work completion dates of the respective outline processes of the outline process plan, the above-determined execution sequences of the detailed works, and the amounts of material.

A more detailed example of a method for creating detailed work plans will be described below.

First, on the respective components assigned to respective work teams, the number of work days of the detailed works are determined, based on the amounts of material of the components. These are computed by prorating the number of work days (the number of days from the work start date to the work completion date) of the outline process that includes these components, by the ratio between the amounts of material of the respective components. For example, in case that an outline process with 60 work days is charged to a work team A and a work team B, it will be assumed that both teams take 60 days to sequentially execute the detailed works on components assigned to themselves. That is, if the execution sequence of the detailed works of components assigned to the work team A is in the order of a component a, a component b, and a component c, and the ratio of material is 2:1:1, then the numbers of work days can be determined to be 30 days for the component a, and 15 days respectively for the component b and the component c. Further, also for the work team B, 60 days can be likewise prorated into the detailed works of the respective components. Herein, the number of work days is rounded off to the closest whole number to be processed into a natural number. However, if this rounding off results in zero day, the number of days of a detail work is set to 1 day by rounding up the number of decimal places. Further, in the event that this processing causes the total number of work days of detailed works to exceed the number of work days of a corresponding outline process work, the number of work days of detailed works is decreased, for example, at least by 1 day in the decreasing order of the number of work days of detailed work. In such a manner or another, the total number of work days of detailed works can be made agree with the number of work days of a corresponding outline process. In reverse, also in case that the total number of work days of detailed works is below the number of work days of a corresponding outline process, the number of work days are increased, for example, at least by 1 day likewise in the decreasing order of the number of work days of detailed work. In such a manner or another, the total number of work days of detailed works can be made agree with the number of work days of the corresponding outline process.

Then, for the respective work teams, the work schedule determination unit 132 sequentially determines the work start dates and the work completion dates of the respective detailed works, based on the work start date of the outline process, the execution sequence of the detailed works, and the above-determined numbers of work days of the respective detailed works. Herein, among all work teams, the work start date of the first-executed detail work is made agree with the work start date of the corresponding outline process. Then, the number of work days of this detailed work is added to the work start date to determine the work completion date. The data of the work start date of a detailed work subsequently executed is determined to be the day next to the work completion date of the previous detailed work, and the number of work days is likewise added to determine the work completion date. By sequentially repeating this process, the work start dates and the work completion dates of all the detailed works corresponding to the component groups assigned to the respective teams can be determined. Herein, the work completion date of the lastly executed detailed work among all the respective work teams unexceptionally agrees with the work completion date of the corresponding outline process.

### [Storing Determination Result, Process 504 in FIG. 10]

Through the above-described process, the contents of the detailed work plans in the designated creation region have been determined. Therefore, then, in process 504, the detailed work plan creation unit 13 subsequently stores the result of the determination to the detailed work plan DB 1e. Concretely, the above-determined respective dates are stored into ‘work start date’ and ‘work completion date’ of the respective corresponding records in the detailed work plan DB 1e. Further, detailed work IDs, which are text strings unique to the respective detailed works, are assigned, and the text strings are stored into the respective corresponding records. The text strings of these detailed work IDs may be formed by appropriately adding serial numbers to the text string of the outline process ID, and may be formed by assigning numerals that enables unique identification of all the detailed works.

[Check/Avoidance of Interference between Work Spaces, Process 505 in FIG. 10]

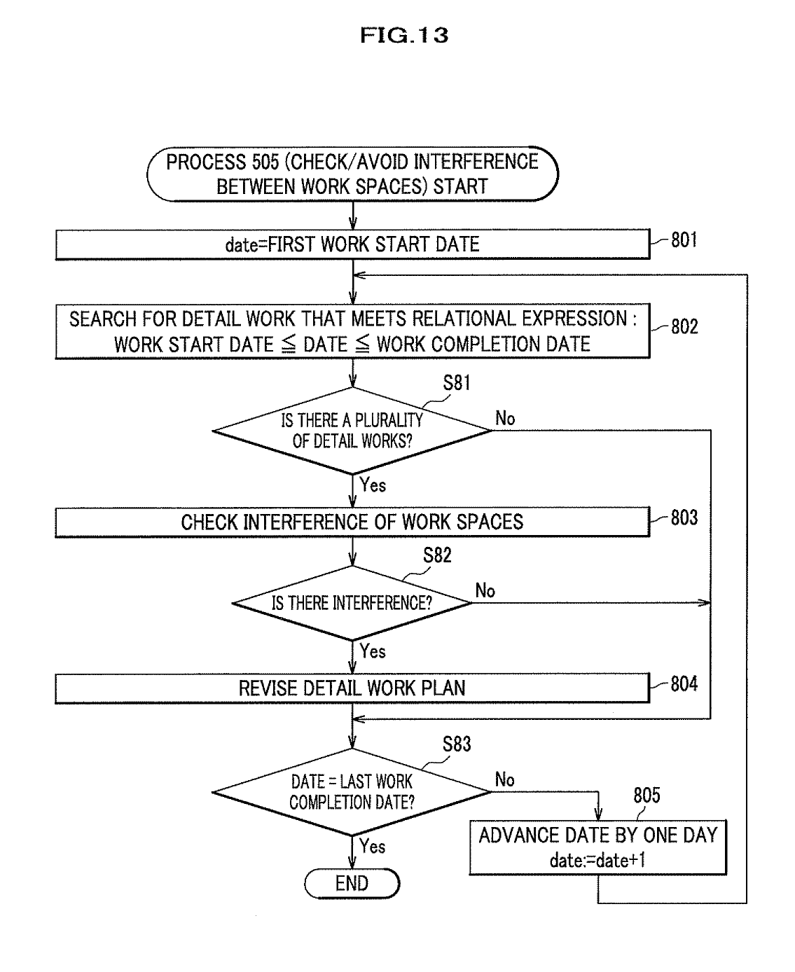

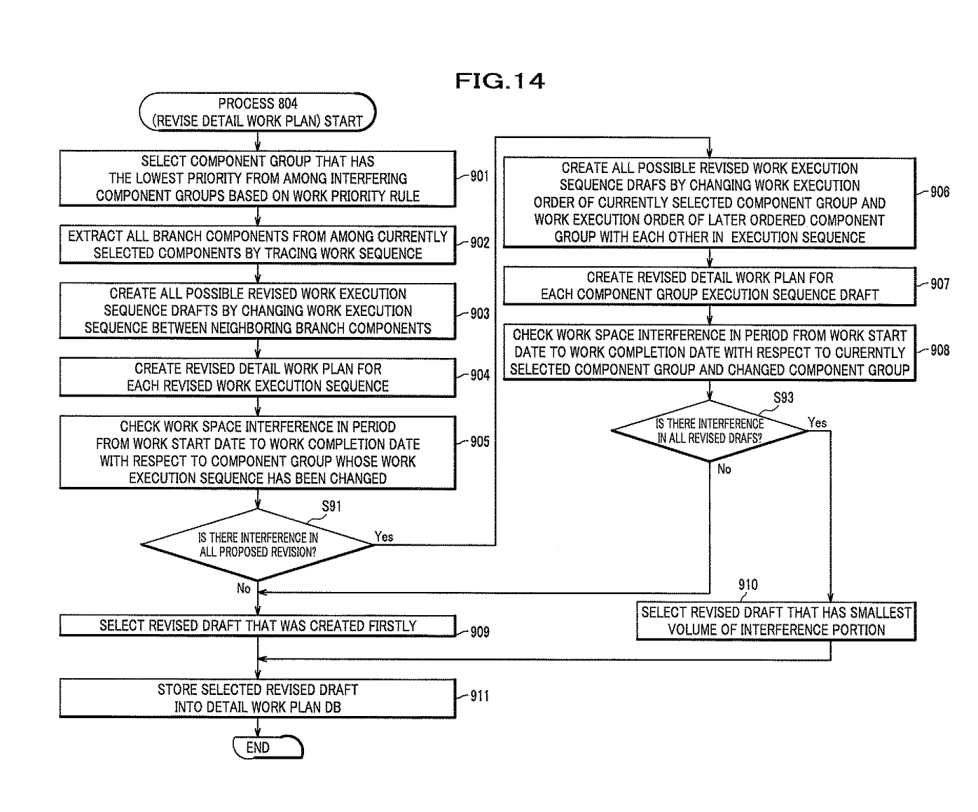

Then, in process 505, the work interference avoidance unit 133 checks presence or absence of interference between work spaces, on the detailed work plans recorded in the respective records in the detailed work plan DB 1e, and if interference occurs, the work interference avoidance unit 133 revises the detailed work plan such as to avoid the interference.

[Detailed Flow of Avoiding Interference between Work Time, FIGS. 13 and 14]

With reference to FIGS. 13 and 14, an interference check-avoidance process (process 505 in FIG. 10) of work spaces to be executed by the work interference avoidance unit 133 will be described below in more details.

In this process, on the detailed work plans as objects, detailed works are checked from the work start date of the detailed work that is executed first (the first work start date) to the work completion date of the detailed work that is completed last (the latest work completion date) are sequentially checked on day-by-day basis. If a plurality of detailed works that are executed on the same day are present, presence or absence of overlapping (interference) between the work spaces of components that correspond to these detailed works is checked. As a result, if interference occurs, the detailed work plan is revised such as to avoid the interference. In checking interference between work spaces, it is also possible that interference occurs between different component kinds. Accordingly, objects of checking include cases that the detailed works of different component kinds are executed on the same day.

As shown in the flowchart in FIG. 13, first, the value of a variable ‘date’ for storing a check data is set to the above-described first work start date (process 801). Then, all the records of detailed works whose check dates are included in the work period (from the work start date to the work completion date) are sought from the detailed work plan DB 1e (process 802).

As a result of search, in case that the number of applicable records is 0 or 1 and more than one applicable detailed works are not present, it is impossible that interference between work spaces occurs. Accordingly, the process branches to process S83 (branching to No in process S81), and it is determined whether the check date agrees with the above-described latest work completion date. If the check date agrees with the latest work completion date, the process is terminated (branching to Yes in process S83). If the check date does not agree with the latest work completion date, the process branches to process 805 (branching to No in process S83), advance the date of the check date by one day, and then returns to process 802 to execute the same process as described above on the next check date.

On the other hand, as a result of search in process 802, if the number of applicable records is greater than or equal to 2, and a plurality of applicable detailed works are present, then the process branches to process 803 (branching to Yes in process S81), and then checks presence or absence of interference between the work spaces of these detailed works. As a result, if no interference is present, the process branches to process S83 (branching to No in process S82), and determines on the check date likewise as described above. If interference is present, the process branches to process 804 (branching to Yes in process S82), and revises the detailed work plan such as to avoid the occurrence of interference. The details of the revising process of a detailed work plan will be described later. Then, in process S83, determination on the check date is performed likewise as described above.

### [Detailed Description of Revising Process of Detailed Work Plan, Process 804 in FIG. 13]

With reference to FIG. 14, the revising process (process 804 in FIG. 13) of a detailed work plan, the revising process being executed by the work interference avoidance unit 133, will be described below in more details.

In the revising process, shown in FIG. 14, of the detailed work plan, first, based on the work sequence restriction and the work priority rule, it is tried to change the execution sequence of detailed works in the same component group. Incase that this is insufficient to avoid occurrence of interference, it is further tried to change the work sequence between component groups. If this is still insufficient to avoid occurrence of interference, finally, a solution that minimizes the volume of the interference portion is sought.

First of all, in process 901, from the detailed work plan DB 1e, component groups, to which components that correspond to the detailed works where interference occurs belong, are sought. For example, in case that interference occurs between two detailed works with detailed work IDs of LP-W1-1 (line 1) and LP-W1-5 (line 5), two component groups with component group IDs of LPGr1 and LPGr2 are sought, as the components groups to which the components (s1 and s5) that correspond to these two detailed works belong. Then, similarly to the case of the work sequence determination unit 131 described above and based on the work priority rule, priority orders are given to the respective component groups, and one component group with lowest priority is selected. Thus, for example, in case that the component group with the largest total weight is prioritized for work, the component group with the smallest total weight (for example, LPGr1) is selected.

Then, in process 902, the execution sequence of the detailed works corresponding to a currently selected component group is changed. Concretely, with reference to the detailed work plan DB 1e, detailed works with earlier sequence orders than those of detailed works which cause interference are traced in reverse order one by one in the currently selected component group, and detailed works with corresponding components being the above-described branch components are all extracted.

Then, in process 903, the selection sequence between all components neighboring the extracted branch components is changed, and in such a manner, all possible execution sequence revised drafts are created as long as generatable. However, as the number of created revised drafts affects the required memory amount and the computation time, an arrangement may be made such as to enable a user to designate the maximum number via the input device 2.

For example, in a component group planned such as to execute the detailed works in an increasing order of the value assigned to each node on the graph in FIG. 17, namely in the order A→B→C→E→F→H→D→G, for example, it will be assumed that a component corresponding to node E causes interference. In this occasion, first, the component corresponding to node C, and second, the component corresponding to node B are extracted as branch components whose execution sequence orders are earlier than node E. Then, the following three are created as execution sequence revised drafts in which the selection sequence between components neighboring these two branch components is changed. Herein, the smaller the number of revised draft is, the smaller the revise range is.
Revised Draft 1: A→B→C→F→H→E→D→G
Revised Draft 2: A→B→D→G→C→E→F→H
Revised Draft 3: A→B→D→G→C→F→H→E

In process 903, if no applicable branch component is found, then the work start component corresponding to node A in FIG. 17 is changed with respect to the execution sequence order, and execution sequence revised drafts are thereby created. For example, in the graph in FIG. 17, with an assumption that interference occurs on the component corresponding to node A or node B, execution sequence revised drafts are created as follows.

$$Revised Draft 4 \text{:} E -> C -> B -> A -> D -> G -> F -> H$$

$$Revised Draft 5 \text{:} E -> C -> B -> D -> G -> A -> F -> H$$

$$Revised Draft 6 \text{:} E -> C -> F -> H -> B -> A -> D -> G$$

$$Revised Draft 7 \text{:} E -> C -> F -> H -> B -> D -> G -> A$$

$$Revised Draft 8 \text{:} H -> F -> C -> B -> A -> D -> G -> E$$

$$…$$

Then, in process 904, the work schedule determination unit 132 creates detailed work plan revised drafts corresponding to the respective created execution sequence revised drafts.

Then, in process 905, on the respective detailed work plan revised drafts, by a procedure same as that of the above-described process in FIG. 13, presence or absence of interference between work spaces is checked in the period from the work start date to the work completion date of the component group whose execution sequence has been changed. As a result, if there are revised drafts in which no interference is present; then the process branches to process 909 (branching to No in process S91); the first created draft is selected from these; the selected revised draft is stored into the detailed work plan DB 1e in process 911; and then the process is terminated.

On the other hand, as a result of checking in process 905, if interference is present in all the revised drafts, then the process branches to process 906 (branching to Yes in process S91), and the work execution sequence between the component groups is changed.

Concretely, in process 906, first, in the work team to which the currently selected component group belongs, the execution order is changed between this component group and the subsequent component groups, and in such a manner, all creatable component group sequence revised drafts are created.

Then, in process 907, the work schedule determination unit 132 creates detailed work plan revised drafts corresponding to the respective created component group sequence revised drafts. Then, in process 908, on the respective detailed work plan revised drafts, by a procedure same as that of the above-described process in FIG. 13, presence or absence of interference between work spaces is checked in the period from the work start date to the work completion date of the component group whose execution sequence order has been changed with that of the currently selected component group. As a result, if there are revised drafts in which no interference is present; then the process branches to process 909 (branching to No in process S93), and the first created draft is selected from these.

On the other hand, as a result of checking in process 908, if interference is present in all the revised drafts, then the process branches to process 910 (branching to Yes in process S93); the volumes of interference portions in the respective revised drafts are computed; and the revised draft that has the smallest value of volume is selected. Then, similarly to the above, the selected revised draft is stored into the detailed work plan DB 1e, and the process is terminated.

As described above, in process 804 (detailed work plan revise), a detailed work plan is revised such as to avoid occurrence of interference between work spaces, and in the event that avoidance is impossible, a detailed work plan is revised such as to minimize the interference region.

### [Overall Process (Detailed Work Plan Display), Process 205 in FIG. 7]

Returning again to FIG. 7, description will be continued. Finally, in process 205, under control by the overall control unit 10, the detailed work plan creation unit 13 reads various data of detailed work plans stored in the detailed work plan DB 1e; display data, such as texts and figures, are transmitted to the output device 3 via the input/output control unit 14; thereby the contents of the created detailed work plans are displayed on the output device 3; and then the process is terminated.

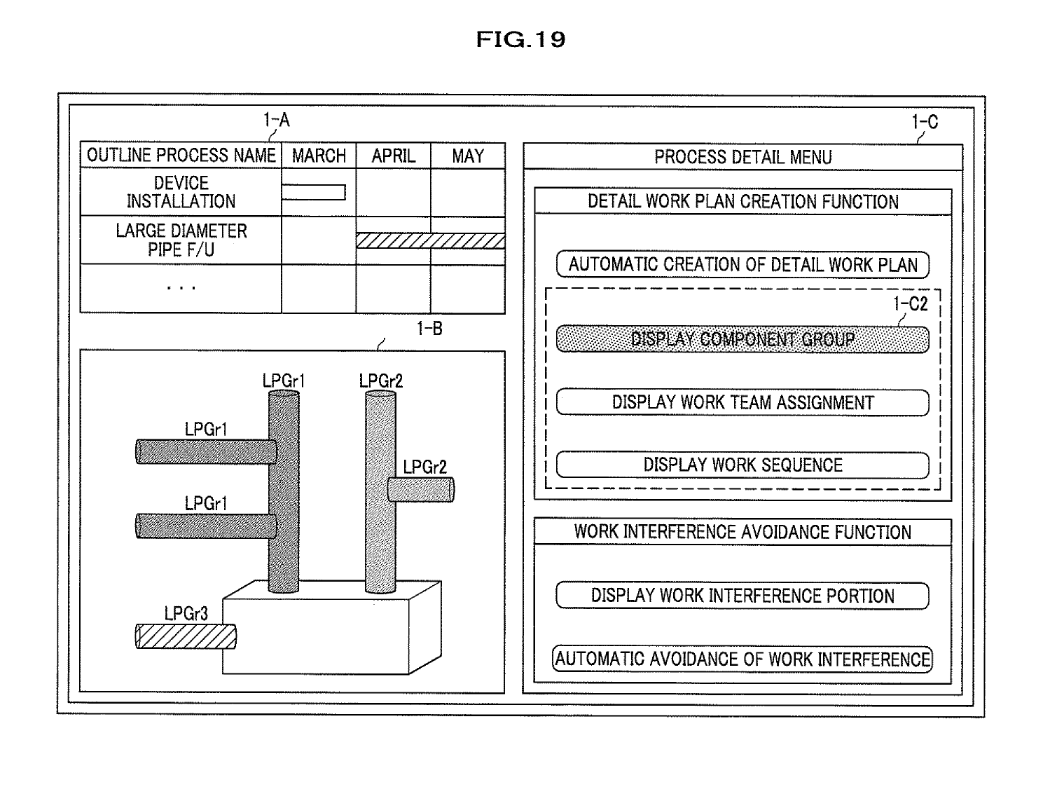

### [Description of Display Screen of Work Plan Creating Apparatus, FIGS. 19 to 23]

It has been described about a series of operation upon selective input via the detailed work plan automatic creation button 1-C1 in the process detailing menu on the screen, shown in FIG. 18 as an example. However, it is also possible to selectively input five buttons, namely from the component group display button 1-C2 to the work interference automatic avoidance button 1-C6 in the process detailing menu one by one from the top, and thereby proceed the process while confirming intermediate results each time on a screen.

FIG. 19 shows an example of screen display of a result of generating component groups, which is displayed on the output device 3, following selective input via the component group display button 1-C2 in the process detailing menu and execution of process 202 (component group generation), in FIG. 8, by the component group generation unit 11.

As shown in FIG. 19, in the three dimensional figure display section 1-B, the names of the generated component groups are additionally displayed on the three dimensional figures of respective components that are installed in a designated work area. The names of these component groups are the component group IDs that are stored in the respective records which have been obtained through a search of the detailed work plan DB 1e (FIG. 6), having keys be the respective component IDs obtained from the component-outline process association DB 1c. Herein, the colors of the three dimensional figures of the components may be displayed in different colors corresponding to respective component group IDs, and corresponding portions in the process chart display section 1-A may be likewise displayed in different colors. Thus, it is possible to distinguish how components are grouped. Further, the associations between the names of components and component group IDs may be displayed by a list in a table format, using another window or the like.

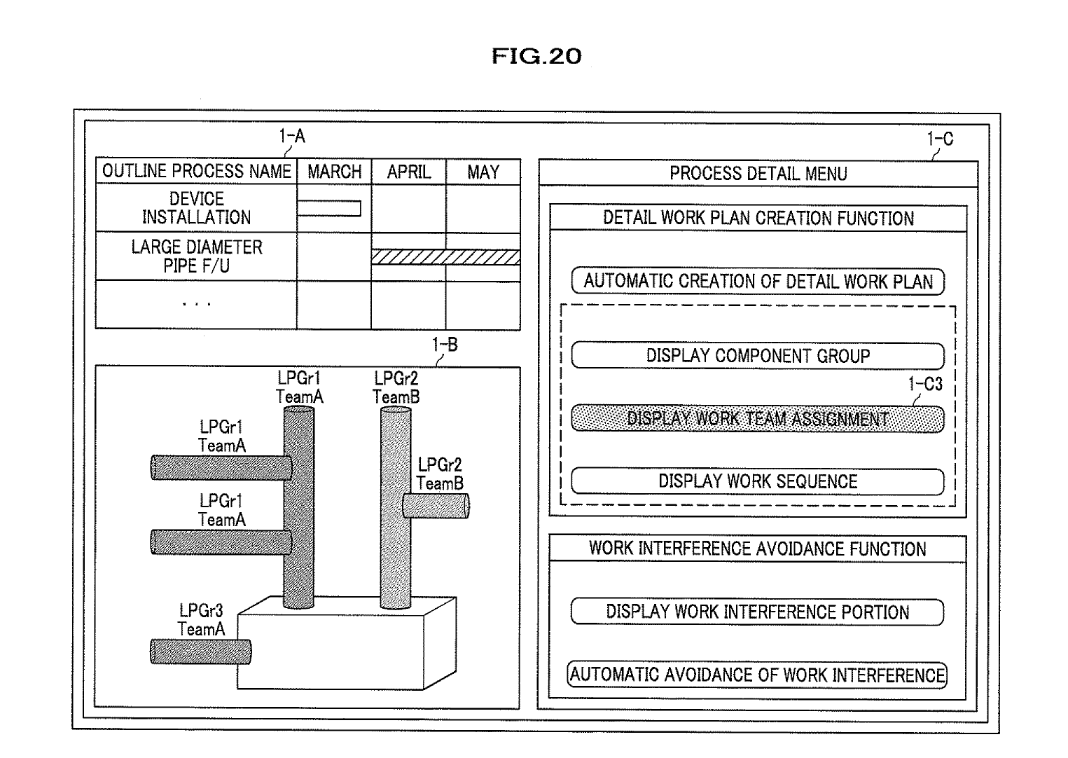

FIG. 20 is an example of screen display, on the output device 3, of a result of work team assignment, following selective input via the work team assignment display button 1-C3 in the process detailing menu and execution of process 203 (work team assignment) in FIG. 9 by the work team assignment unit 12.

As shown in FIG. 20, on the three dimensional figures of respective components installed in the object region, the three dimensional figure display section 1-B displays the names of work teams to which these component groups have been assigned, in addition to the names of the component groups. The names of these work teams are those stored in respective records obtained through a search of the detailed work plan DB 1e (FIG. 6), having keys be the respective component IDs obtained from the component-outline process association DB 1c. Herein, the three dimensional figures of components may be displayed in different colors corresponding to respective work teams, and the background portions of the respective three dimensional figures may be displayed in corresponding different colors. In such a manner, it is possible to distinguish which work team is in charge of work of components to be installed at which place. Further, the associations between the names of component groups or components, and the names of work teams, may be displayed by a list in a table format, using another window or the like.

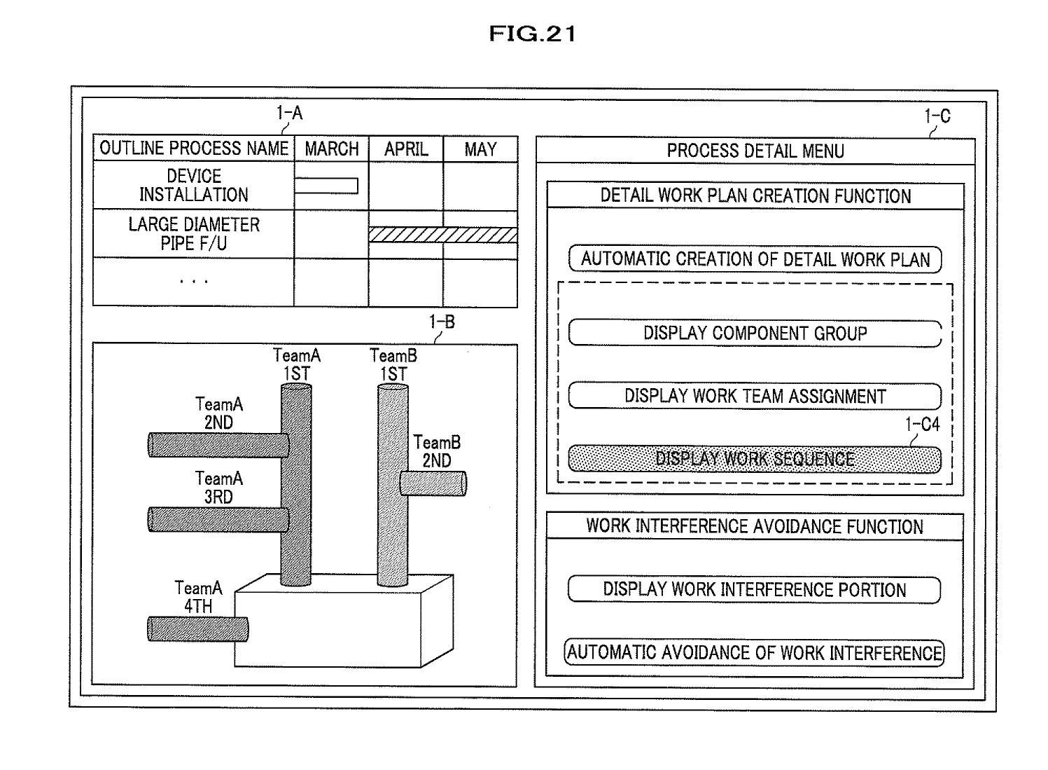

FIG. 21 is an example of screen display, on the output device 3, of a result of determination of the execution sequences of detailed works, following selective input via the work sequence display button 1-C4 in the process detailing menu and execution of process 504 (storing a determination result) in FIG. 10 by the work sequence determination unit 131.

As shown in FIG. 21, on the three dimensional figures of respective components installed in the object region, the three dimensional figure display section 1-B displays information indicating the execution sequence in each work team, in addition to the names of work teams to which these components have been assigned. The information on execution sequence is generated from work sequence numbers stored in respective records obtained through a search of the detailed work plan DB 1e (FIG. 6), having keys be respective component IDs obtained from the component-outline process association DB 1c. In such a manner, it is possible to distinguish in which sequence each individual work team executes detailed works. Further, the associations between the names of components, the names of work teams, and execution sequence may be displayed by a list in a table format, using another window or the like.

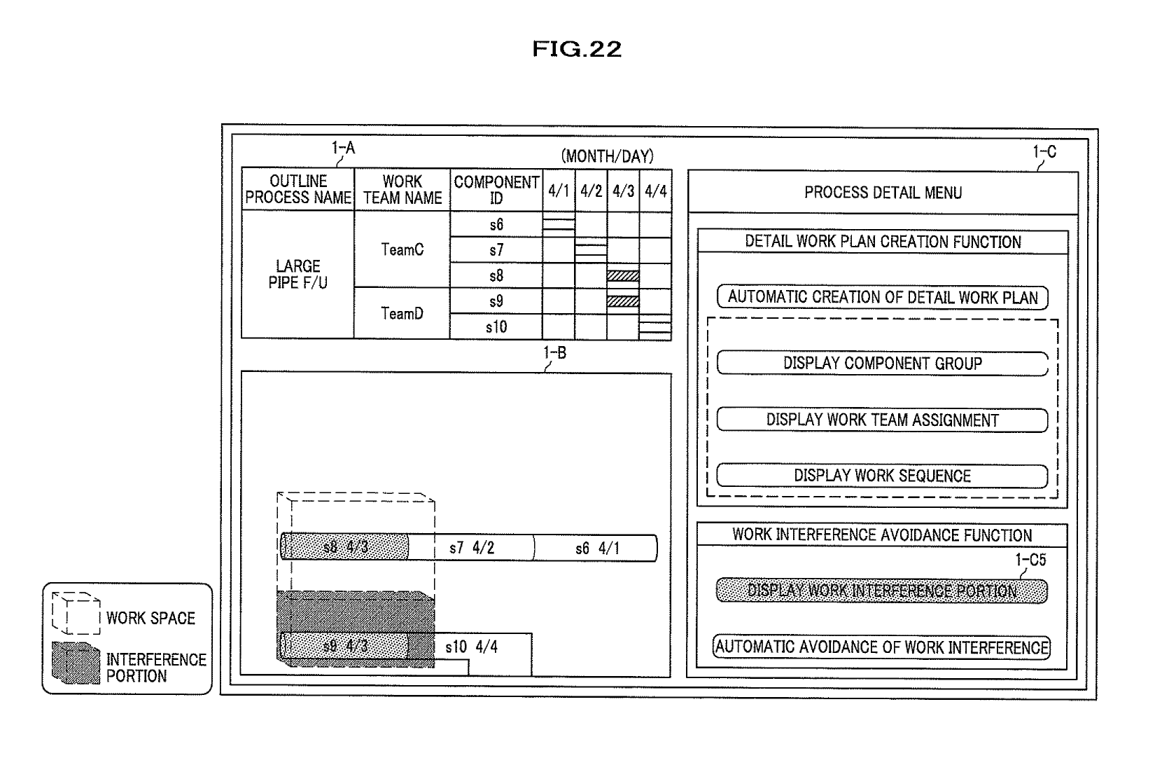

FIG. 22 is an example of screen display, on the output device 3, of interference portions between work spaces, wherein the interference portions are displayed in case that interference portions are present in process S82, as a result of the following process. That is, the work interference portion display button 1-C5 in the process detailing menu is selectively input, and process 505 (work space interference check/avoidance) in FIG. 10 is executed by the work interference avoidance unit 133.

As shown in FIG. 22, the process chart display section 1-A displays the execution dates of the detailed works of respective components in a predetermined format; the three dimensional figure display section 1-B displays the three dimensional figures of components causing mutual interference in colors, for example in a red color, to enable distinguishing components having interference. Further, as shown in FIG. 22 as an example, it is also possible to clearly display the position and the size of a spatial interference portion by displaying a certain work space of these components together in the three dimensional figure display section 1-B. Still further, it is also possible to recognize the execution dates of works causing interference, by displaying, for example, the work dates of these components on the three dimensional figures of respective components or in the vicinity, using text strings and another window.

Further, in the process charts of the detailed work plans displayed in the process chart display section 1-A, schedules corresponding to components that cause interference may be displayed in color, for example in a red color.

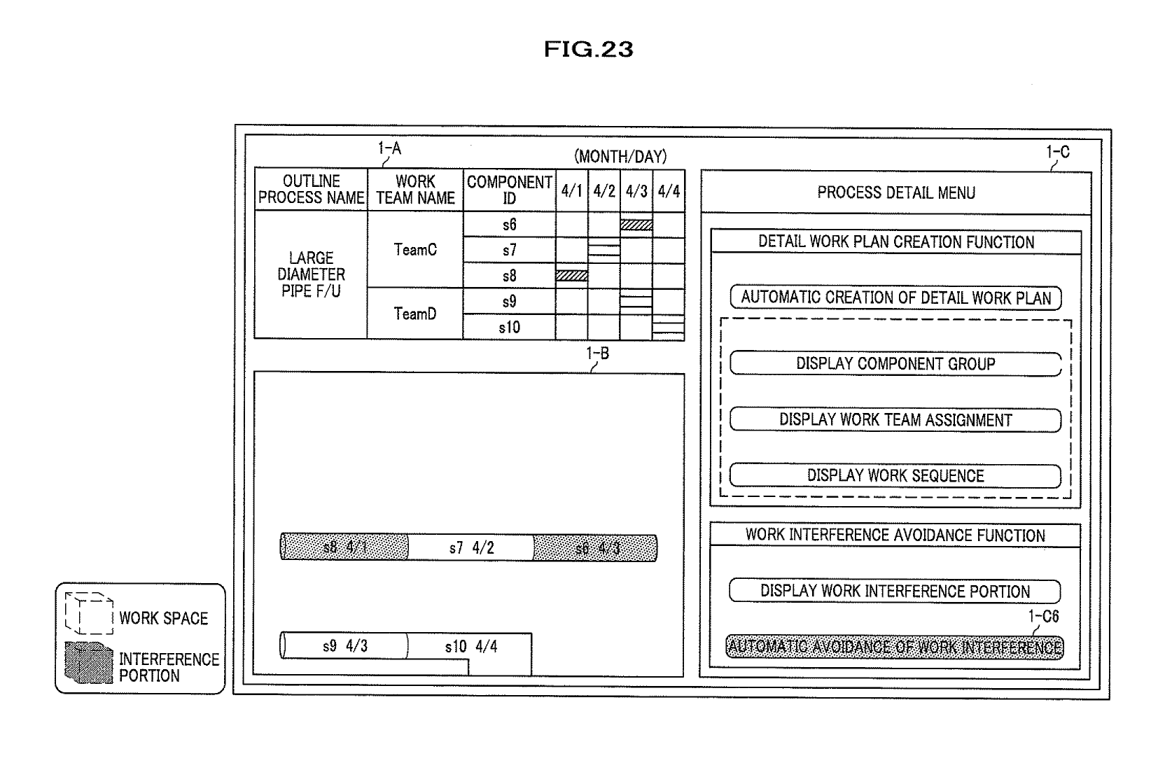

FIG. 23 is an example of screen display, on the output device 3, of a result of avoidance of interference between work spaces. Concretely, in case that interference is present, as shown in FIG. 22 as an example, upon selective input of the work interference automatic avoidance button 1-C6, the work interference avoidance unit 133 executes process 804 (detailed work plan revise) in FIG. 13, and then the output display 3 displays a result avoidance of interference between work spaces.

Herein, in case that revise has been made on work sequence numbers, work start dates, or the like stored in the detailed work plan DB 1e to avoid work interference, if, for example, the detailed work IDs of revising object works are stored in a memory, then revised portions can be distinguishably displayed, for example, by displaying changed schedule portions in the process chart display section 1-A, figures of amendment object components in the three dimensional figure display section 1-B, or the like, in a specific color. Further, for example, by displaying the execution dates of works of these components in the vicinity of the figures of these components, using text objects and another window, it is also possible, by just viewing the three dimensional figure display section 1-B, to recognize the execution dates of works of respective components after avoiding interference.

According to the present invention, it is possible to aid creation of detailed work plans such as to enable parallel works on a plurality of components which are present in the same work area and also to prevent occurrence of spatial interference between works.

What is claimed is:

1. A work plan creating method for creating detailed work plans, wherein an outline process plan of works of assembling a structure with a plurality of components on site, and attribute information including kinds, three-dimensional shapes, and installation positions of the components, are given, and wherein a detailed work plan is created on component-by-component basis, by using the outline process plan and the attribute information, the method comprising the steps of:
providing a work plan creating apparatus which performs the work plan creating method;
a component group generating step of generating component groups by dividing the plurality of components into units of work assignment, corresponding to the respective kinds of the plurality of components;
a work team assigning step of assigning, with a predetermined standard, the each generated component group to one or more work teams having been assigned in the outline process plan to an outline process that corresponds to the each generated component group;
a detailed work plan creating step of creating each detailed work plan by determining an execution sequence and a work schedule of detailed works on component-by-component basis in a corresponding work team, based on a predetermined work sequence restriction and a predetermined work priority rule; and
a work interference avoiding step, wherein, among individual detailed works that form a created detailed work plan, if there are a plurality of detailed works that are executed in parallel and cause work interference due to overlapping between work spaces, the step revises the execution sequence of the detailed works, such as to avoid the work interference.

2. The work plan creating method according to claim 1,
wherein in the component group generating step:
each connection relationship between components is judged, based on attribute information on the components;
each one component group is generated by grouping components that are in a corresponding connection relationship; and
if a volume ratio of a portion of overlapping between work spaces of component groups among the generated component groups, the portion of overlapping being obtained by connecting certain work spaces that are computed from attribute information on components, is larger than a predetermined value, the component groups with the portion of overlapping are grouped with each other to generate one component group.

3. The work plan creating method according to claim 1,
wherein the kinds of the components include equipment unit, pipe, and at least one of floor, ceiling, and wall.

4. The work plan creating method according to claim 1,
wherein in the work team assigning step:
a total amount of material of the components forming the each corresponding component group is computed from the attribute information on the components; and
referring to worker head-counts of the respective work teams and amounts of material having been assigned,
component groups are assigned, in a decreasing order of the total amount of material of the component group, to a work team whose amount of material per worker becomes the smallest when the component group is assigned to the work team.

5. The work plan creating method according to claim 1,
wherein in the detailed work plan creating step,
first, an execution sequence on component group-by-component group basis is determined between a plurality of component groups that correspond to each individual outline process, and then, according to the determination result, an execution sequence of detailed works on component-by-component basis is determined between a plurality of components that form the same component group.

6. The work plan creating method according to claim 5,
wherein with regard to a work schedule of the detailed works, for each individual work team to which works of a corresponding outline process have been assigned, a number of workdays of a corresponding component is computed by prorating a number of work days between a work start date and a work completion data of the corresponding outline process, based on the amount of material of the component on which the corresponding work team executes working,
and wherein, according to the determined execution sequence of the detailed works, a work start date and a work completion date of the detailed works that correspond to the each component are sequentially determined.

7. The work plan creating method according to claim 5,
wherein in the detailed work plan creating step,
the work sequence restriction is defined by presence of a component including a floor, a ceiling, or a wall having already been installed, or a component that is to be connected,
and the work priority rule includes a rule of determining a work sequence, based on at least one of install positions and amounts of material of the components.

8. The work plan creating method according to claim 7,
wherein an installation position of the each component includes at least one of a height from the floor and a distance from the wall.

9. The work plan creating method according to claim 7,
wherein, in case that the kind of a component is pipe, the work priority rule includes a rule that determines a work sequence, based on at least one of a diameter of each pipe and a direction of a fluid that flows in the pipe.

10. The work plan creating method according to claim 1,
wherein in the work interference avoiding step,
the revise of the execution sequence of the detailed works to avoid interference is performed by:
trying revise of execution sequence of detailed works in a component group that includes components which cause work interference; if the work interference cannot be thereby avoided, trying revise of execution sequence between the component group and a component group of the same kind on component group-by-component group basis; and if still the work interference cannot be avoided yet, adopting a revised draft that minimizes a total amount of work interference between component groups.

11. The work plan creating method according to claims 1,
wherein the work plan creating apparatus makes an output device display a screen that includes at least one of a three dimensional figure display section which displays the shapes and the installation positions of the components in three dimensional figures, and a process chart display section that displays the outline process plan or the detailed work plans in a predetermined format.

12. A work plan creating apparatus for creating detailed work plans, wherein an outline process plan of works of assembling a structure with a plurality of components on site, and attribute information including kinds, three-dimensional shapes, and installation positions of the components, are given, and wherein a detailed work plan is created on component-by-component basis, by using the outline process plan and the attribute information, the apparatus comprising:
a component group generating unit for generating component groups by dividing the plurality of components into units of work assignment, corresponding to the respective kinds of the plurality of components;
a work team assigning unit for assigning, with a predetermined standard, the each generated component group to one or more work teams having been assigned in the outline process plan to an outline process that corresponds to the each generated component group;
a detailed work plan creating unit for creating each detailed work plan by determining an execution sequence and a work schedule of detailed works on component-by-component basis in a corresponding work team, based on a predetermined work sequence restriction and a predetermined work priority rule;
a work interference avoiding unit, wherein, among the individual detailed works that form a created detailed work plan, if a detailed work is present that is executed in parallel with another detailed work and causes work interference due to overlapping between work spaces, the work interference avoiding unit revises the execution sequence of the detailed works that cause the work interference such as to avoid the work interference; and
a graphical user interface that provides at least one of a function to display a result of generating the component groups, associating the components and the corresponding component groups with each other, a function to display a result of assigning the component groups to the corresponding work teams, associating the components and the corresponding work teams with each other, a function to display a result of creating the each detailed work plan, associating the components, the corresponding work team, and the execution sequence in the corresponding work team with each other, and a function to display a result of revising the execution sequence of the corresponding detailed works.

13. The work plan creating apparatus according to claim 12,
wherein the association between the components and the corresponding component groups, the association between the components and the corresponding work teams, or the association between the components, the corresponding work teams, and the execution sequences of the corresponding work teams, is distinguishably displayed, by changing a display form including a display color, in at least one of a three dimensional figure display section and a process chart display section.

14. The work plan creating apparatus according to claim 12,
wherein, in case that, among the individual detailed works that form a created detailed work plan, if a detailed work is present that is executed in parallel with another detailed work and causes work interference due to overlapping between work spaces, the graphical user interface distinguishably displays, by changing a display form including a display color, the overlapping portion of the work spaces, in at least one of a three dimensional figure display section and the process chart display section.
